(19) United States
(12) Patent Application Publication
(10) Pub. No.: US 2026/0246960 A1
(43) Pub. Date: Aug. 20, 2026

(54) ENCODING METHOD, DECODING METHOD, AND RELATED DEVICE

(71) Applicant: VIVO MOBILE COMMUNICATION CO., LTD., Dongguan (CN)

(72) Inventors: Wei ZHANG, Dongguan (CN); Guiqi WANG, Dongguan (CN); Ren HUANG, Dongguan (CN); Fuzheng YANG, Dongguan (CN); Zhuoyi LV, Dongguan (CN)

(21) Appl. No.: 19/643,850

(22) Filed: Apr. 10, 2026

Related U.S. Application Data
(63) Continuation of application No. PCT/CN2024/123305, filed on Oct. 8, 2024.

(30) Foreign Application Priority Data
Oct. 10, 2023 (CN) 202311312190.6

(51) Int. Cl. H04N 19/513; H04N 19/147; H04N 19/159; H04N 19/172; H04N 19/597

(52) U.S. Cl. CPC H04N 19/513; H04N 19/147; H04N 19/159; H04N 19/172; H04N 19/597

(57) ABSTRACT

A decoding method is provided, which includes decoding, by a decoding side, a target code stream, to obtain first identification information; and copying, by the decoding side in a case that the first identification information indicates that an encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block, where the point cloud information comprises at least one of geometric encoding information or attribute encoding information of a point cloud corresponding to the second point cloud block.

### CROSS-REFERENCE TO RELATED APPLICATIONS

This application is a continuation of International Patent Application No. PCT/CN2024/123305, filed on Oct. 8, 2024, which claims priority to Chinese Patent Application No. 202311312190.6, filed on Oct. 10, 2023 in China, both of which are incorporated herein by reference in their entireties.

### TECHNICAL FIELD

This application relates to the field of codec technologies, and in particular, to an encoding method, a decoding method, and a related device.

### BACKGROUND

In the related art, a prediction entropy encoding mode is used to encode a current point cloud frame when performing inter prediction encoding of point clouds. Specifically, based on a relationship between a size of a node corresponding to the current point cloud frame and a size of a node corresponding to a largest prediction unit (Largest Prediction Unit, LPU), the current point cloud frame is encoded by using a reference point cloud as prediction information, or the current point cloud frame is encoded by using a motion-compensated point cloud as prediction information.

### SUMMARY

Embodiments of this application provide an encoding method, a decoding method, and a related device.

According to a first aspect, an encoding method is provided, including:
copying, by an encoding side in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and
generating, by the encoding side, a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block, and the point cloud information includes at least one of geometric encoding information and attribute encoding information of a point cloud corresponding to the second point cloud block.

According to a second aspect, a decoding method is provided, including:
decoding, by a decoding side, a target code stream, to obtain first identification information; and
copying, by the decoding side in a case that the first identification information indicates that an encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block, where the point cloud information includes at least one of geometric encoding information and attribute encoding information of a point cloud corresponding to the second point cloud block.

According to a third aspect, an encoding apparatus is provided, including:
a first copying module, configured to copy, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and
a generating module, configured to generate a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block, and the point cloud information includes at least one of geometric encoding information and attribute encoding information of a point cloud corresponding to the second point cloud block.

According to a fourth aspect, a decoding apparatus is provided, including:
a fourth obtaining module, configured to decode a target code stream, to obtain first identification information; and
a second copying module, configured to copy, in a case that the first identification information indicates that an encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block, where the point cloud information includes at least one of geometric encoding information and attribute encoding information of a point cloud corresponding to the second point cloud block.

According to a fifth aspect, an electronic device is provided. The terminal includes a processor and a memory, the memory stores a program or an instruction that can be run on the processor, and when the program or the instruction is executed by the processor, the steps of the method according to the first aspect or the steps of the method according to the second aspect are implemented.

According to a sixth aspect, an electronic device is provided, including a processor and a communication interface, where the processor is configured to: copy, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and generate a target code stream based on first identification information, where the first identification information is used to indicate to a decoding side that an encoding side copies the point cloud information of the second point cloud block or the point cloud information of the second point cloud block subjected to motion compensation to the reconstructed point cloud of the first point cloud block, and the point cloud information includes at least one of geometric encoding information and attribute encoding information of a point cloud corresponding to the second point cloud block; or the processor is configured to: decode a target code stream, to obtain first identification information; and copy, in a case that the first identification information indicates that the encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block, where the point cloud information includes at least one of geometric encoding information and attribute encoding information of a point cloud corresponding to the second point cloud block.

According to a seventh aspect, an electronic device is provided, including: a memory, configured to store video data, and a processing circuit, configured to implement the steps of the method according to the first aspect, or implement the steps of the method according to the second aspect.

According to an eighth aspect, a readable storage medium is provided. The readable storage medium stores a program or an instruction, and the program or the instruction is executed by a processor to implement the steps of the method according to the first aspect or the steps of the method according to the second aspect.

According to a ninth aspect, a codec system is provided, including an encoding side device and a decoding side device. The encoding side device may be configured to perform the steps of the method according to the first aspect, and the decoding side device may be configured to perform the steps of the method according to the second aspect.

According to a tenth aspect, a chip is provided. The chip includes a processor and a communication interface, the communication interface is coupled to the processor, and the processor is configured to run a program or an instruction, to implement the steps of the method according to the first aspect or the steps of the method according to the second aspect.

According to an eleventh aspect, a computer program/program product is provided, where the computer program/program product is stored in a storage medium, and the program/program product is executed by at least one processor to implement the steps of the method according to the first aspect or the steps of the method according to the second aspect.

In the embodiments of this application, an encoding side copies, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and the encoding side generates a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block. According to the solution, when a similarity between two point cloud blocks is high enough, point cloud information of one point cloud block is directly copied to a reconstructed point cloud of the other point cloud block.

### BRIEF DESCRIPTION OF DRAWINGS

FIG. 1 is a schematic diagram of a codec system according to an embodiment of this application;

FIG. 2 is an encoding flowchart executed by an encoder based on an MPEG G-PCC encoding framework;

FIG. 3 is an encoding flowchart executed by an encoder based on an MPEG G-PCC encoding framework;

FIG. 4 is a decoding flowchart executed by a decoder based on an AVS-PCC decoding framework;

FIG. 5 is a decoding flowchart executed by a decoder based on an MPEG G-PCC decoding framework;

FIG. 6 is a schematic diagram of using inter prediction information of geometric encoding based on octree;

FIG. 7 is a schematic diagram of a motion prediction procedure based on PU;

FIG. 8 is a schematic diagram of encoding a motion vector and using prediction information;

FIG. 9 is a first schematic flowchart of an encoding method according to an embodiment of this application;

FIG. 10 is a second schematic flowchart of an encoding method according to an embodiment of this application;

FIG. 11 is a third schematic flowchart of an encoding method according to an embodiment of this application;

FIG. 12 is a schematic diagram of motion search according to an embodiment of this application;

FIG. 13 is a schematic flowchart of a decoding method according to an embodiment of this application;

FIG. 14 is a schematic diagram of modules of an encoding apparatus according to an embodiment of this application;

FIG. 15 is a schematic diagram of modules of a decoding apparatus according to an embodiment of this application;

FIG. 16 is a block diagram of a structure of an electronic device according to an embodiment of this application; and

FIG. 17 is a structural block diagram of a terminal according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

Terms such as “first” and “second” in this application are used to distinguish between similar objects, and are not used to describe a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in this application, “or” indicates at least one of connected objects. For example, “A or B” covers three solutions, namely, solution 1: including A and not including B; solution 2: including B and not including A; and solution 3: including A and B. A character “/” generally indicates an “or” relationship between the associated objects.

Before the technical solutions provided in the embodiments of this application are described, meanings of some terms are first described.

Point cloud (Point Cloud): Point cloud refers to a group of discrete point sets which are irregularly distributed in space and express a spatial structure and surface attributes of a three-dimensional object or a three-dimensional scenario. Point clouds may be classified into different categories according to different classification standards. For example, based on an obtaining manner, the point clouds may be classified into a dense point cloud and a sparse point cloud; and for another example, based on a temporal type, the point clouds may be classified into a static point cloud and a dynamic point cloud.

Point cloud data (Point Cloud Data): Geometric coordinate information and attribute information of each point in the point cloud together constitute the point cloud data. The geometric coordinate information may also be referred to as three-dimensional position information. Geometric coordinate information of a point in the point cloud refers to spatial coordinates (x, y, z) of the point, and may include coordinate values of the point in all coordinate axis directions of a three-dimensional coordinate system, for example, a coordinate value x in an X axis direction, a coordinate value y in a Y axis direction, and a coordinate value z in a Z axis direction. Attribute information of a point in the point cloud may include at least one of the following: color information, material information, or laser reflection intensity information (also referred to as reflectivity). Generally, each point in the point cloud has same pieces of attribute information. For example, each point in the point cloud may have two types of attribute information: color information and laser reflection intensity. For another example, each point in the point cloud may have three types of attribute information: color information, material information, and laser reflection intensity information.

Point cloud compression (Point Cloud Compression, PCC): Point cloud compression refers to a process of encoding geometric coordinate information and attribute information of each point in the point cloud, to obtain a compressed code stream. Point cloud compression may include two main processes: geometric coordinate information encoding and attribute information encoding. At present, a point cloud encoding framework that may compress the point cloud may be a geometry point cloud compression (Geometry Point Cloud Compression, G-PCC) codec framework or a video point cloud compression (Video Point Cloud Compression, V-PCC) codec framework provided by a moving picture experts group (Moving Picture Experts Group, MPEG), or an AVS-PCC codec framework provided by an audio video standard (Audio Video Standard, AVS).

Point cloud decompression: Point cloud decompression refers to a process of decoding the compressed code stream obtained from point cloud compression, to reconstruct the point cloud. Specifically, it refers to a process of reconstructing geometric coordinate information and attribute information of each point in the point cloud based on a geometric bitstream and an attribute bitstream in the compressed code stream. After the compressed code stream is obtained at a decoding side, for the geometric bitstream, entropy decoding is firstly performed to obtain quantized information of each point in the point cloud, and then inverse quantization is performed to reconstruct geometric coordinate information of each point in the point cloud. For the attribute bitstream, firstly, entropy decoding is performed to obtain quantized attribute residual information or a quantized transform coefficient of each point in the point cloud; and then inverse quantization is performed on the quantized attribute residual information to obtain reconstructed residual information, inverse quantization is performed on the quantized transform coefficient to obtain a reconstructed transform coefficient, inverse transform is performed on the reconstructed transform coefficient to obtain reconstructed residual information, and the attribute information of each point in the point cloud may be reconstructed based on the reconstructed residual information of each point in the point cloud. Reconstructed attribute information of each point in the point cloud corresponds to reconstructed geometric coordinate information one by one in order, to reconstruct the point cloud.

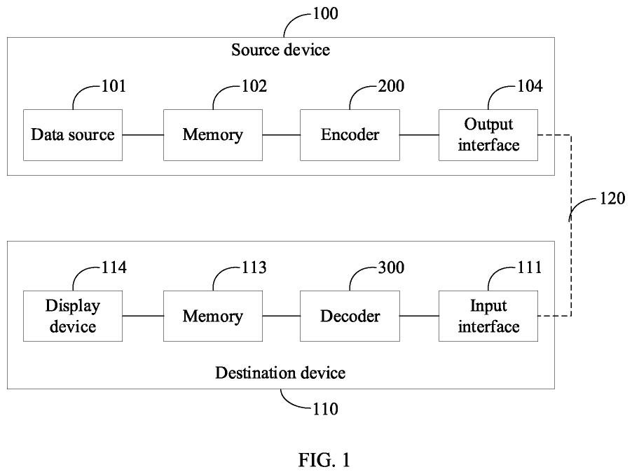

FIG. 1 is a schematic diagram of a codec system according to an embodiment of this application. The technical solutions of this embodiment of this application relate to codec (CODEC) of point cloud data (including encoding or decoding).

As shown in FIG. 1, the codec system includes a source device 100, and the source device 100 provides encoded point cloud data that is decoded and displayed by a destination device 110. Specifically, the source device 100 provides point cloud data to the destination device 110 via a communication medium 120. The source device 100 and the destination device 110 may include any one or more of the following: a desktop computer, a notebook (namely, laptop) computer, a tablet computer, a set-top box, a mobile phone, a wearable device (such as a smart watch or a wearable camera), a television, a camera, a display device, vehicle user equipment, a virtual reality (virtual reality, VR) device, an augmented reality (Augmented reality, AR) device, a mixed reality (mixed reality, MR) device, a digital media player, a video game console, a video conference device, a video streaming transmission device, a broadcast receiver device, a broadcast transmitter device, a spacecraft, an airplane, a robot, a satellite, and the like.

In the example of FIG. 1, the source device 100 includes a data source 101, a memory 102, an encoder 200, and an output interface 104. The destination device 110 includes an input interface 111, a decoder 300, a memory 113, and a display device 114. The source device 100 is an example of an encoding device, and the destination device 110 is an example of a decoding device. In other examples, the source device 100 and the destination device 110 may not include some components in FIG. 1, or may alternatively include components other than those in FIG. 1. For example, the source device 100 may obtain point cloud data through an external capture device. Similarly, the destination device 110 may be connected to an external display device interface without including an integrated display device. For another example, the memory 102 and the memory 113 may be external memories.

Although the source device 100 and the destination device 110 are depicted as separate devices in FIG. 1, in some examples, the two may be integrated in one device. In such embodiments, same hardware or software, or separate hardware or software, or any combination thereof may be used to implement a function corresponding to the source device 100 and a function corresponding to the destination device 110.

In some examples, the source device 100 and the destination device 110 may perform unidirectional data transmission or bidirectional data transmission. In a case of bidirectional data transmission, the source device 100 and the destination device 110 may operate in a substantially symmetrical manner, that is, each of the source device 100 and the destination device 110 includes an encoder and a decoder.

The data source 101 represents a source of point cloud data (namely, original and uncoded point cloud data) and provides the encoder 200 with the point cloud data, and the encoder 103 encodes the point cloud data. The source device 100 may include a capture device (such as a camera device, a sensing device, or a scanning device), an archive including previously captured point cloud data, or a feeder interface for receiving point cloud data from a data content provider. The camera device may include an ordinary camera, a stereo camera, a light field camera, or the like. The sensing device may include a laser device, a radar device, or the like. The scanning device may include a three-dimensional laser scanning device or the like. Point cloud data may be obtained by collecting real-world visual scenes through the capture device. Alternatively, the data source 101 may generate data based on computer graphics as source data, or combine real-time data, archived data, and computer-generated data. For example, the data source generates point cloud data based on a virtual object (such as a virtual three-dimensional object and a virtual three-dimensional scene obtained through three-dimensional modeling).

The encoder 200 encodes captured, pre-captured, or computer-generated data. The encoder 200 may rearrange the point cloud data from a receiving order (sometimes referred to as “display order”) in an encoding order. The encoder 200 may generate a bitstream including encoded point cloud data. The source device 100 may then output the encoded point cloud data onto the communication medium 120 via the output interface 104 for reception or retrieval by, for example, the input interface 111 of the destination device 110.

The memory 102 of the source device 100 and the memory 113 of the destination device 110 represent general-purpose memory. In some examples, the memory 102 may store original data from the data source 101, and the memory 113 may store decoded point cloud data from the decoder 300. Additionally or alternatively, the memory 102 and the memory 113 may respectively store software instructions that can be executed by, for example, the encoder 200 and the decoder 300. Although the memory 102 and the memory 113 are shown separately from the encoder 200 and the decoder 300 in this example, it should be understood that the encoder 200 and the decoder 300 may further include internal memories for functionally similar or equivalent purposes. If the encoder 200 and the decoder 300 are deployed on a same hardware device, the memory 102 and the memory 113 may be the same memory. In addition, the memory 102 and the memory 113 may store, for example, encoded point cloud data that is output from the encoder 200 and is input to the decoder 300. In some examples, portions of the memory 102 and the memory 113 may be allocated as one or more point cloud buffers, for example, for storing original, decoded, or encoded point cloud data.

In some examples, the source device 100 may output encoded data from the output interface 104 to the memory 113. Similarly, the destination device 110 may access encoded data from the memory 113 via the input interface 111. The memory 113 or the memory 102 may include any of various distributed or locally accessed data storage media, such as a hard drive, a blue-ray disc, a digital versatile disc (Digital Versatile Disc, DVD), a compact disc read-only memory (Compact Disc Read-Only Memory, CD-ROM), a flash memory, a volatile or non-volatile memory, or any other suitable digital storage media for storing encoded point cloud data.

The output interface 104 may include any type of medium or device capable of transmitting encoded point cloud data from the source device 100 to the destination device 110. For example, the output interface 104 may include a transmitter or transceiver, such as an antenna, configured to transmit encoded point cloud data directly from the source device 100 to the destination device 110 in real time. The encoded point cloud data may be modulated according to a communication standard of a wireless communication protocol, and transmitted to the destination device 110.

The communication medium 120 may include an instantaneous medium such as wireless broadcast or wired network transmission. For example, the communication medium 120 may include a radio frequency (radio frequency, RF) spectrum or one or more physical transmission lines (for example, cables). The communication medium 120 may form a part of a packet-based network (for example, a local area network, a wide area network, or a global network such as the Internet). The communication medium 120 may also be in the form of a storage medium (for example, a non-transitory storage medium), such as a hard disk, a flash drive, a compact disk, a digital point cloud disk, a blue-ray disc, a volatile or non-volatile memory or any other suitable digital storage medium for storing encoded point cloud data.

In some implementations, the communication medium 120 may include a router, a switch, a base station, or any other device that can be used to facilitate communication from the source device 100 to the destination device 110. For example, a server (not shown) may receive encoded point cloud data from the source device 100 and provide it to the destination device 110, for example, provide it to the destination device 110 via network transmission. The server may include a web server (for example, for a website), a server configured to provide a file transfer protocol service (such as a file transfer protocol (File Transfer Protocol, FTP) or a file delivery over unidirectional transport (File Delivery Over Unidirectional Transport, FLUTE) protocol), a content delivery network (content delivery network, CDN) device, a hypertext transfer protocol (Hypertext Transfer Protocol, HTTP) server, a multimedia broadcast multicast service (Multimedia Broadcast Multicast Service, MBMS) or evolved MBMS (evolved Multimedia Broadcast Multicast Service, eMBMS) server, a network-attached storage (Network-attached storage, NAS) device, or the like. The server may implement one or more HTTP streaming protocols, such as an MPEG media transport (MPEG Media Transport, MMT) protocol, a dynamic adaptive streaming over HTTP (Dynamic Adaptive Streaming over HTTP, DASH) protocol, an HTTP live streaming (HTTP Live Streaming, HLS) protocol, or a real time streaming protocol (Real Time Streaming Protocol, RTSP).

The destination device 110 may access the encoded point cloud data from the server, for example, through a wireless channel (such as a Wi-Fi connection) or a wired connection (such as a digital subscriber line (Digital subscriber line, DSL) or a cable modem) for accessing the encoded point cloud data stored on the server.

The output interface 104 and the input interface 111 may represent a wireless transmitter/receiver, a modem, a wired networking component (for example, an Ethernet card), a wireless communication component operating according to IEEE 802.11 standards or IEEE 802.15 standards (for example, ZigBee™), Bluetooth standards, and the like, or other physical components. In an example in which the output interface 104 and the input interface 111 include wireless components, the output interface 104 and the input interface 111 may be configured to transfer data, such as the encoded point cloud data based on WIFI, Ethernet, a cellular network (such as a 4th generation mobile communication technology (4th Generation Mobile Communication Technology, 4G), Long Term Evolution (Long Term Evolution, LTE), Advanced LTE, a 5th generation mobile communication technology (5th Generation Mobile Communication Technology, 5G), or a 6th generation mobile communication technology (6th Generation Mobile Communication Technology, 6G)).

The technology provided in this embodiment of this application can be applied to support one or more of the following application scenarios: a machine perception point cloud, which can be used in scenarios such as an autonomous navigation system, a real-time inspection system, a geographic information system, a visual sorting robot, and a rescue and disaster relief robot; and a human eye perception point cloud, which can be used in point cloud application scenarios such as digital cultural heritage, free-view broadcasting, three-dimensional immersive communication, and three-dimensional immersive interaction.

The input interface 111 of the destination device 110 receives an encoded bitstream (bitstream) from the communication medium 120. The encoded bitstream may include a high-level syntax element and an encoded data unit (such as a sequence, a picture group, a picture, a slice, or a block), where the high-level syntax element is used to decode the encoded data unit, to obtain decoded point cloud data. The display device 114 displays the decoded point cloud data to a user. The display device 114 may include a cathode ray tube (Cathode ray tube, CRT), a liquid-crystal display (liquid-crystal display, LCD), a plasma display, an organic light-emitting diode (organic light-emitting diode, OLED) display, or other types of display devices. In some examples, the destination device 110 may not have the display device 114, for example, if the decoded point cloud data is used to determine a position of a physical object, the display device 114 may be replaced with a processor.

The encoder 200 and the decoder 300 may be implemented as one or more of various processing circuits, and the processing circuit may include a microprocessor, a digital signal processor (Digital Signal Processor, DSP), an application specific integrated circuit (Application Specific Integrated Circuit, ASIC), a field programmable gate array (Field Programmable Gate Array, FPGA), discrete logic hardware, or any combination thereof. When the technology is fully or partially implemented in software, the device may store an instruction for the software in an appropriate non-transient computer-readable storage medium, and use one or more processors to execute the instruction in hardware to execute the technology provided in this embodiment of this application.

Basic principles of the encoder 200 and the decoder 300 provided in this embodiment of this application are described below by using the G-PCC codec framework and the AVS-PCC codec framework as examples.

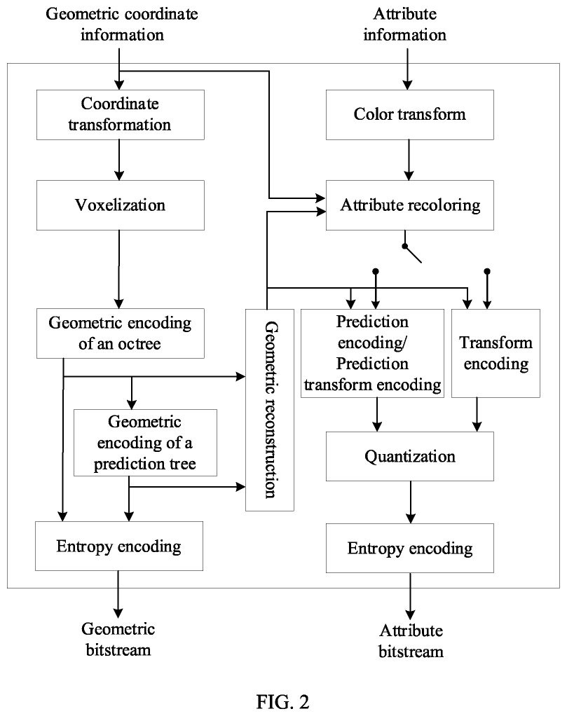

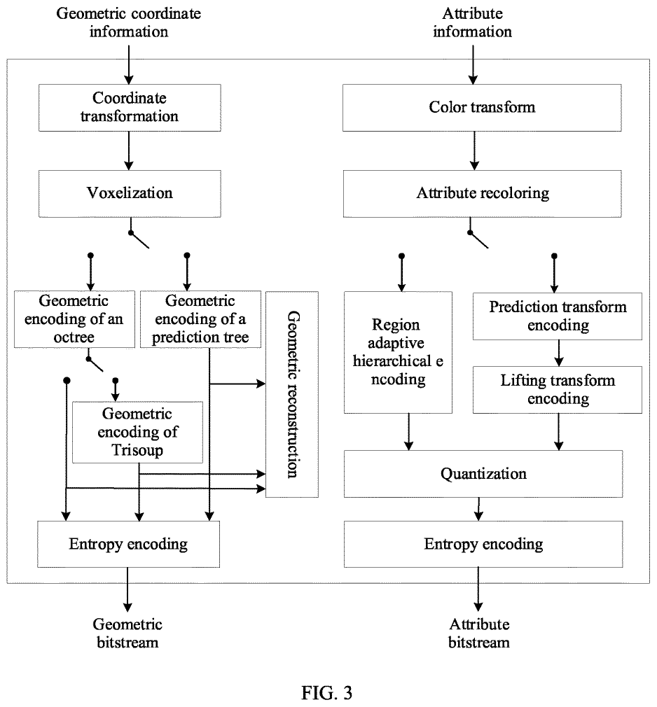

The G-PCC codec framework and the AVS-PCC codec framework are basically the same. FIG. 2 is an encoding flowchart executed by an encoder based on an AVS-PCC encoding framework, FIG. 3 is an encoding flowchart executed by an encoder based on an MPEG G-PCC encoding framework, and the encoder may be the encoder 200 shown in FIG. 1. The encoding framework can be generally divided into a geometric coordinate information encoding process and an attribute information encoding process. In the geometric information encoding process, geometric coordinate information of each point in the point cloud is encoded to obtain a geometric bitstream; in the attribute information encoding process, attribute information of each point in the point cloud is encoded to obtain an attribute bitstream; and the geometric bitstream and the attribute bitstream together form the compressed code stream of the point cloud.

For the geometric information encoding process, an encoding flow executed by the encoder 200 is as follows.

1. Pre-processing (Pre-Processing): It may include transform coordinates (Transform Coordinates) and Voxelize (Voxelize). Through scaling and translation operations, the pre-processing is to convert point cloud data in three-dimensional space into integer form, and move a minimum geometric position of the point cloud data to the origin of coordinates. In some examples, the encoder 200 may not perform pre-processing.

2. Geometric encoding: For the AVS-PCC encoding framework, the geometric encoding includes two modes: geometric encoding based on an octree (Octree) and geometric encoding based on a prediction tree. For the G-PCC encoding framework, the geometric encoding includes three modes: geometric encoding based on an octree, geometric encoding based on Trisoup (Trisoup), and prediction encoding based on a prediction tree. Where:

Geometric encoding based on an octree: Firstly, coordinate transformation is performed on geometric information, so that all point clouds are included in a bounding box (bounding box) determined by two extreme points (0, 0, 0) and (2^{d}, 2^{d}, 2^{d}), and then voxelization is performed, that is, quantization, rounding, and removal of duplicate points (determined based on parameters). Then, based on an order of breadth-first traversal, octree split is continuously performed on non-empty subcubes (including points in the point cloud) in the bounding box. At a same octree depth, one node is split into eight child nodes, and the split may stop until a leaf node obtained through split is a unit cube of 1×1×1. An 8-bit binary code generated based on whether there is point occupancy (1 indicates occupancy and 0 indicates no occupancy) in the subcube is referred to as an occupancy code (Occupancy Code). An occupancy code of each node is encoded to generate a binary code stream.

The octree is a tree data structure. In three-dimensional space division, a preset bounding box (bounding box) is evenly divided, and each node has eight child nodes. An occupancy state of each child node of the octree is indicated by using “1” and “0”, and occupancy code information (Occupancy Code) is obtained as the code stream of the point cloud geometric information.

Geometric encoding based on a prediction tree: Firstly, input point clouds are sorted, where current sorting methods include disorder, Morton order, azimuth order, and radial distance order. A prediction tree structure is established in two different ways at the encoding side, including: a high-latency slow mode (KD-Tree) and splitting each point into different lasers (Laser) by using lidar calibration information, and establishing the prediction structure based on the different lasers (low-latency fast mode). Next, based on the structure of the prediction tree, each node in the prediction tree is traversed, and a prediction residual is obtained by selecting different prediction modes to predict geometric position information of the node, and the geometric prediction residual is quantized by using a quantization parameter. Finally, through continuous iteration, the prediction residual, the prediction tree structure, and the quantization parameter of the node position information of the prediction tree are encoded to generate a binary code stream.

Geometric encoding based on Trisoup: Firstly, the octree is split. Unlike geometric information encoding based on the octree structure, this method does not require splitting the point cloud level by level down to a bottom leaf node with a side length of 1.1.1. Instead, it is split into a leaf node of a specified side length. Surface information formed by voxels within the node is then represented by using a series of triangle meshes (triangle mesh). In GPCC, a parameter: trisoup node size, is used to represent a size of a block (block) in which a triangle patch is located. When trisoup node size is greater than 0, one geometric surface patch is used to represent a voxel set in the node, and at most twelve intersections generated by the geometric surface patch and twelve sides of the block are referred to as vertexes (vertex). Vertex coordinates of each block are encoded in turn to generate a binary code stream.

3. Geometry entropy encoding (Geometry Entropy Encoding): Statistical compression encoding is performed on occupancy code information of the octree, the prediction residual information of the prediction tree, and vertex information of Trisoup, and finally a binary (0 or 1) compressed code stream is output. Statistical encoding is a lossless encoding mode, which may effectively reduce a code rate needed to express a same signal. A commonly used statistical encoding mode is content adaptive binary arithmetic coding (Content Adaptive Binary Arithmetic Coding, CABAC).

4. Geometric reconstruction: Decode and reconstruct geometric information obtained after geometric encoding.

For the attribute information encoding process, an encoding flow executed by the encoder 200 is as follows.

1. Color transform: Apply transform to transform color information of attributes into different domains. For example, color information can be transformed from RGB color space to YCbCr color space.

2. Attribute recoloring (Recoloring): In a case of lossy encoding, after the geometric coordinate information is encoded, the encoding side needs to decode and reconstruct the geometric information, that is, restore geometric information of each point in the point cloud. Search for attribute information corresponding to one or more adjacent points in an original point cloud as attribute information of the reconstructed point.

In some examples, the encoder 200 may not perform color transform or attribute recoloring.

3. Attribute information processing: In AVS-PCC, attribute information processing may include three modes: prediction (Prediction) encoding, transform (Transform) encoding, and prediction and transform (Prediction&Transform) encoding. The three encoding modes may be used under different conditions.

Prediction encoding refers to determining, based on information such as a distance or spatial relationship, an adjacent point of a to-be-encoded point in encoded points as a prediction point, and calculating prediction attribute information of the to-be-encoded point based on attribute information of the prediction point according to a set criterion. A difference between real attribute information and the prediction attribute information of the to-be-encoded point is calculated as attribute residual information, and quantization, transform (optional), and entropy encoding are performed on the attribute residual information.

Transform encoding refers to grouping and transforming attribute information, and quantizing a transform coefficient by using transform methods such as discrete cosine transform (Discrete Cosine Transform, DCT) and Haar transform (Haar Transform, Haar); obtaining attribute reconstruction information through inverse quantization and inverse transform; calculating a difference between real attribute information and the attribute reconstruction information to obtain attribute residual information, and quantizing the attribute residual information; and performing entropy encoding on a quantized transform coefficient and attribute residual.

Prediction and transform encoding refers to performing transform by using the attribute residual information obtained through prediction, and performing quantization and entropy encoding on the transform coefficient.

In MPEG G-PCC, attribute information processing may include three modes: prediction transform (Prediction Transform) encoding, lifting transform (Lifting Transform) encoding, and region adaptive hierarchical transform (Region Adaptive Hierarchical Transform, RAHT) encoding. The three encoding modes can be used under different conditions.

Prediction transform encoding refers to selecting a subset of points based on a distance, dividing the point cloud into several different levels of detail (Level of Detail, LoD), and realizing multi-quality hierarchical point cloud representation from rough to fine. Bottom-up prediction can be realized between adjacent levels, that is, an adjacent point in a rough level predicts attribute information of a point introduced in a fine level, to obtain corresponding attribute residual information. A lowest-level point is encoded as reference information.

Lifting transform encoding refers to introducing a weight updating strategy of an adjacent point on the basis of LoD adjacent level prediction, and finally obtaining prediction attribute information of each point, and obtaining corresponding attribute residual information.

Region adaptive hierarchical transform encoding refers to converting a signal into a transform domain through RAHT transform of attribute information, which is referred to as a transform coefficient.

4. Attribute information quantization (Attribute Quantization): Fineness of quantization is usually determined by a quantization parameter. A transform coefficient or attribute residual information obtained from attribute information processing is quantized, and entropy encoding is performed on a quantized result. For example, in prediction transform encoding and lifting transform encoding, entropy encoding is performed on quantized attribute residual information; and in RAHT, entropy encoding is performed on a quantized transform coefficient.

5. Entropy encoding (Entropy Encoding): Generally, the quantized attribute residual information and/or transform coefficient are/is finally compressed by using run length coding (Run Length Coding) and arithmetic coding (Arithmetic Coding). Information such as a corresponding encoding mode and quantization parameter is also encoded by using an entropy encoder.

The encoder 200 encodes geometric coordinate information of each point in the point cloud to obtain a geometric bitstream, and encodes attribute information of each point in the point cloud to obtain an attribute bitstream. The encoder 200 may transmit the encoded geometric bitstream and attribute bitstream to the decoder 300.

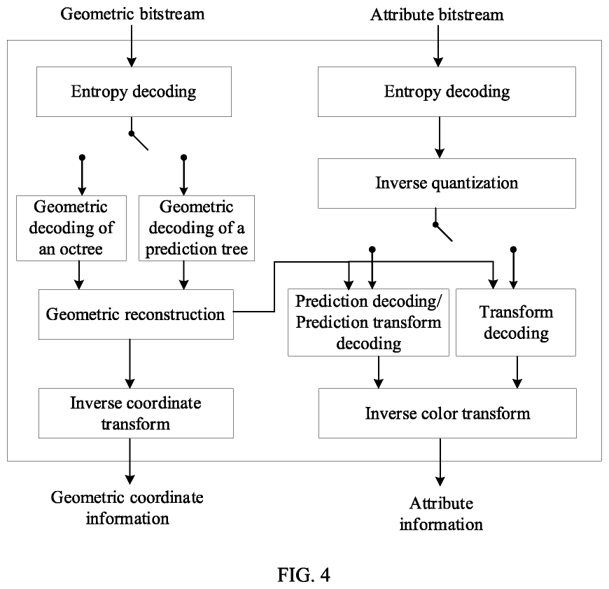

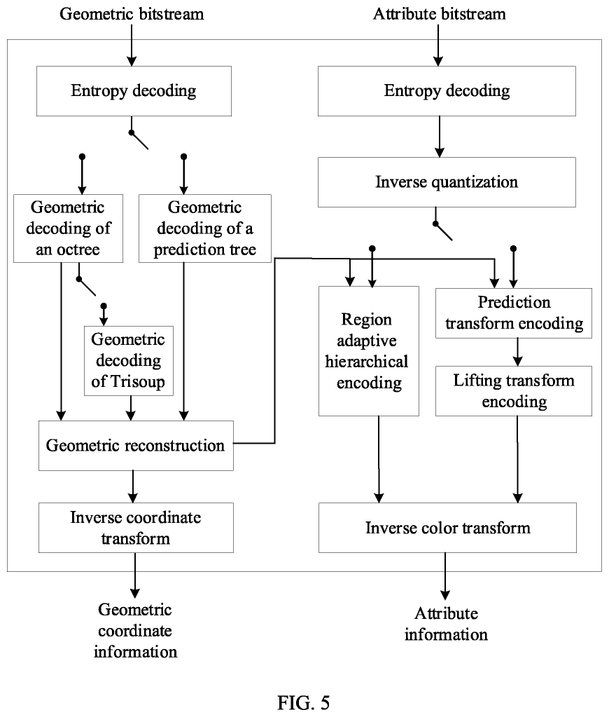

FIG. 4 is a decoding flowchart executed by a decoder based on an AVS-PCC decoding framework, FIG. 5 is a decoding flowchart executed by a decoder based on an MPEG G-PCC decoding framework, and the decoder may be the decoder 300 shown in FIG. 1. After receiving the compressed code stream (namely, the attribute bitstream and the geometric bitstream) transmitted by the encoder 200, the decoder 300 decodes the geometric bitstream to reconstruct geometric coordinate information of each point in the point cloud, and decodes the attribute bitstream to reconstruct attribute information of each point in the point cloud.

A decoding flow executed by the decoder 300 is as follows.

1. Entropy decoding (Entropy Decoding): Perform entropy decoding on the geometric bitstream and the attribute bitstream separately to obtain a geometric syntax element and an attribute syntax element.

2. Geometric decoding: For the AVS-PCC encoding framework, the geometric decoding includes two modes: geometric decoding based on an octree (Octree) and geometric decoding based on a prediction tree. For the G-PCC encoding framework, the geometric decoding includes three modes: geometric decoding based on an octree, geometric decoding based on Trisoup (Trisoup), and prediction decoding based on a prediction tree.

Geometric decoding based on an octree: Obtain an occupancy code of each node through continuous parsing based on an order of breadth-first traversal, continuously split the node in turn until a unit cube of 1×1×1 is obtained, obtain a number of points included in each leaf node through parsing, and finally recover point cloud information of geometric reconstruction.

Geometric decoding based on a prediction tree: A decoding side reconstructs a prediction tree structure by continuously parsing the code stream, then obtains geometric position prediction residual information and a quantization parameter of each prediction node through parsing, performs inverse quantization on the prediction residual to recover reconstructed geometric position information of each node, and finally completes geometric reconstruction of the decoding side.

Geometric decoding based on Trisoup: To decode the geometric coordinates of the point cloud from a node triangle patch, it is necessary to check whether each voxel in a node cube intersects with the triangle patch. The technology is referred to as triangular rasterization, and intersection tests are conducted by using six unit vectors (0,0,1), (0,0,1), (0,0,1), (0,0,1), (0,0,1), and (0,0,1), to check whether each unit vector intersects with the triangle patch. If the unit vector intersects with the triangle patch, an intersection point is calculated and a decoded cube is output. A number of generated points in the decoder is determined by a grid distance d.

3. Geometric reconstruction: Perform reconstruction to obtain geometric coordinate information of points in the point cloud.

4. Inverse coordinate transform: Perform inverse transform on the reconstructed geometric coordinate information to transform reconstructed coordinates (positions) of points in the point cloud from the transform domain back to an initial domain.

5. Inverse quantization: Perform inverse quantization on the attribute syntax element.

6. Attribute information processing: In AVS-PCC, attribute information processing is used to determine color information of points in the point cloud through prediction or prediction transform on an inverse-quantized prediction residual or a prediction residual transform coefficient, or determine color information of points in the point cloud through transform on an inverse-quantized transform coefficient.

In MPEG G-PCC, attribute information processing is used to determine the color information of the points in the point cloud through RAHT on inverse-quantized attribute information, or determine the color information of the points in the point cloud through LOD and inverse lifting on inverse-quantized attribute information.

7. Inverse color transform: Transform the color information from the YCbCr color space to the RGB color space. In some examples, a color inverse transform operation may not be performed.

Related information of this application is described below.

### (I) Use of Inter Prediction Information

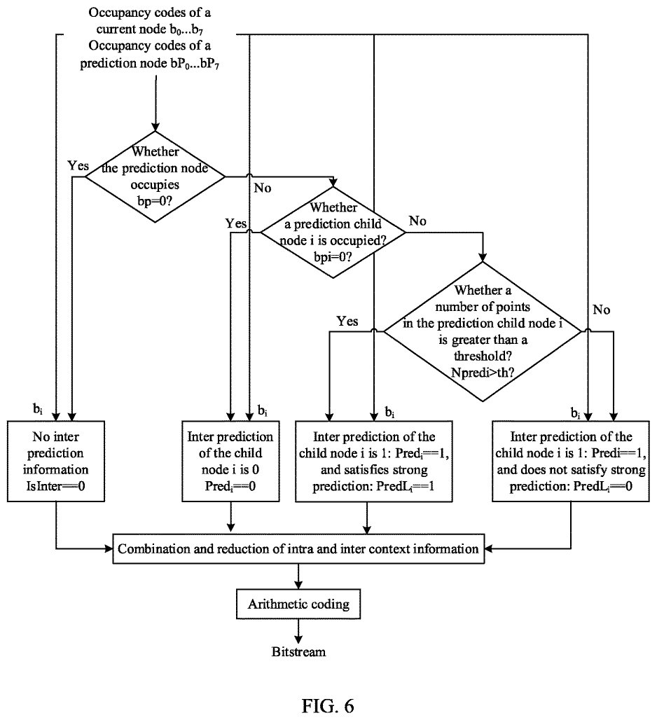

As shown in FIG. 6, a prediction node occupancy code may be obtained directly from a reference frame point cloud or from a compensation point cloud, depending on whether motion compensation has been performed on the current node. Based on an occupancy state of the prediction node, the inter prediction information is classified into the following categories.

(1) No pred: When the prediction node occupancy code is zero (bP=0), that is, none of its child nodes is occupied, the inter prediction information is not used.

(2) Pred0: When a prediction child node i is empty, the child node i is predicted as not occupied, bPᵢ=0.

Pred1: When the prediction child node i is not empty, the child node i is predicted as occupied, bPᵢ=1; and in this case, based on the number of points included in the node, there are two cases.

Case 1: predL=1: When the prediction child node i is not empty and the number of points (points) in it exceeds a threshold th, the child node i is strongly predicted as occupied.

Case 2: predL=0: When the prediction child node i is not empty and the number of points (points) in it does not exceed the threshold th, the child node i is not strongly predicted.

Optionally, the threshold is set to 2 in TMC13 v23 and GES.

### (II) Local Motion Estimation

For a non-radar dense point cloud, G-PCC performs only local motion estimation, and determines whether a level should enable local motion estimation based on a local motion enabled flag (localMotionEnabled) of a geometric point cloud slice level (gbs level). Local motion estimation is based on block (prediction unit) for inter prediction. Firstly, a size of an LPU and a number of levels for block prediction are read from configuration parameters, and a size of a minimum prediction unit: min LPU (min LPUsize) is calculated.

(a) When a node size of the current level>LPUsize, there is no motion vector to perform motion compensation on the reference point cloud, so occupancy information of the reference point cloud (without motion compensation) is directly used as an inter prediction context.

(b) When the node size of the current level=LPUsize, firstly, it is determined whether a number of points in the prediction block is greater than 50, and determine whether to enable local motion, and then write a recursive prediction unit structure (PU_tree). Each node may continue to be split downward, and a motion vector of a child node PU is used to perform motion compensation on the reference point cloud, or a motion vector of a current unsplit node is directly used to perform motion compensation on the reference point cloud. PU_tree records a flag bit (split_flag) of whether to split downward, a flag of whether to compensate in a current level (isCompensated), and a motion vector set (MVs). If the node is split to minLPUsize, further split is terminated (split_flag==0), and motion compensation is performed (isCompensated==1). Finally, based on the flag of performing compensation or not, it is determined to use reference point cloud occupancy information or compensation point cloud occupancy information as the inter prediction context.

### (III) Motion Prediction Procedure Based on a Prediction Unit or a Prediction Block (Prediction Unit, PU)

One PU includes the following parameters:
popul_flags: PU occupancy states;
split_flags: downward split flags;
MVs: motion vectors;
isCompensated: if it is 1, it indicates that the reference point cloud has been motion-compensated; and if it is 0, it indicates that the reference point cloud has not been compensated; and
hasMotion: used to identify whether the node includes motion information. If it includes the motion information, it is 1; otherwise, it is 0.

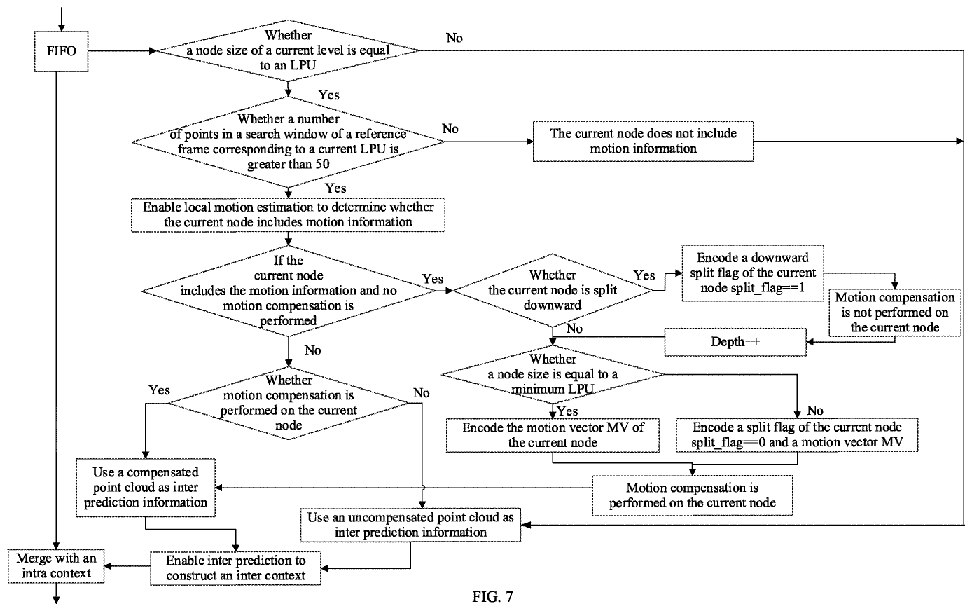

For the motion prediction procedure based on PU, refer to FIG. 7.

### (IV) Rate Distortion Optimization-Based Motion Vector and Determination of Motion Compensation

### 1. Selection and Encoding of an Optimal Motion Vector

(1.1) Motion search motion vector (Motion Vector, MV) (How to obtain the motion vector MV)
i. Motion estimation criterion: log( ) of a sum of absolute differences (Manhattan distance) between each point in a prediction block and a to-be-encoded block is used as a matching metric;

$$D ( B , P ) = {\sum }_{b ∈ B} {log}_{2} ( 1 + {min}_{p ∈ P} {‖ b - p ‖}_{1} ) ,$$

where
B represents a to-be-encoded block, P represents a prediction block, D(B,P) represents a distortion metric between the prediction block and the to-be-encoded block, b represents a point in the to-be-encoded block, p represents a point in the prediction block, and l represents a l-norm; and
ii. Search algorithm: within a search window, search for best two motion vectors in surrounding 18 directions starting from a position of the reference node. Through iteration of a search step, a search distance is progressively narrowed until an optimal motion vector is finally obtained.

### (1.2) Calculate a Code Rate for Encoding Each MV

Set a context based on a value of the MV: whether the motion vector is 0 (mvIsZero), whether the motion vector is 1 (mvIsOne), a sign bit of the motion vector (mvSign), a context index of an exponential-Golomb encoding motion vector (ctxLocalMV), and calculating an entropy of an encoded MV; and

determining of the best MV is associated with the flag of whether to split downward.

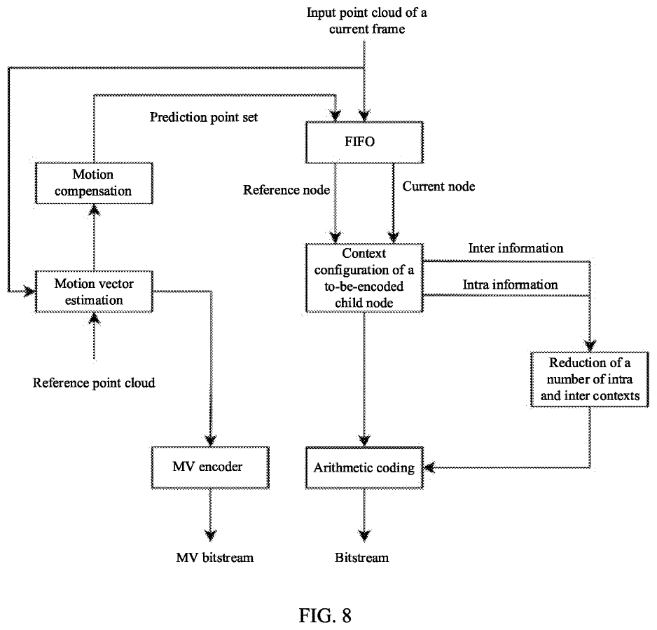

For the procedure of encoding the motion vector and using the prediction information, refer to FIG. 8.

### (V) Based on Rate Distortion Optimization (Rate Distortion Optimization, RDO), Select Whether the PU is Split Downward

The flag of whether to split downward (split_flag) is determined based on a total cost (Cost) of distortion between the reference node and the current node, the encoded MV, and an encoded split_flag (if it is 0, the reference node is not compensated; otherwise, the reference node is compensated).

A calculation process of Cost:

Both the flag split_flag indicating whether to split downward and different PU motion vectors (MVs) are optional encoding parameters. By using a specific set of encoding parameters (for example, when not split downward split_flag==0, a motion vector MV1 is selected), a code rate and distortion under this condition can be obtained, that is, a rate distortion performance (R, D). To find an encoding parameter with a minimum distortion (D) in a case of meeting a certain code rate limit (R), a Lagrange factor is introduced to calculate the following cost:

$$C = \sum i [ D ( B , P ( W , Vi ) ) + λ R ( Vi ) ] + λ R ( split flags ) + λ R ( pop flags ) ,$$

where

C represents a rate distortion cost, B represents a to-be-encoded block, P represents a prediction block, R represents a size of an encoded code stream, λ represents a Lagrange factor between D and R, W represents a size of the search window, Vi represents a motion translation vector, and pop flags represents an occupation identifier of a subblock obtained after split.

By comparing costs of split downward or not, a best motion vector and a split_flag of the current PU block are determined.

With reference to the accompanying drawings, an encoding method provided in the embodiments of this application is described in detail by using some embodiments and application scenarios thereof.

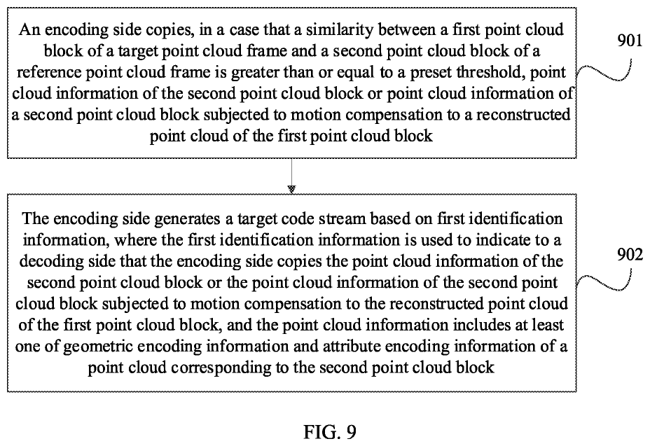

As shown in FIG. 9, this embodiment of this application provides an encoding method, including the following steps.

Step 901: An encoding side copies, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block.

Optionally, the reference point cloud frame is a previous point cloud frame adjacent to the target point cloud frame.

The point cloud information includes at least one of geometric encoding information or attribute encoding information of a point cloud corresponding to the second point cloud block.

A manner of the copying point cloud information of the second point cloud block or point cloud information of a second point cloud block subjected to motion compensation to a reconstructed point cloud of the first point cloud block may also be described as an inter prediction skip mode.

By copying the geometric encoding information of the second point cloud block or the second point cloud block subjected to motion compensation to the reconstructed point cloud of the first point cloud block, it is convenient to directly use the geometric encoding information to encode attribute information of the first point cloud block subsequently, thereby omitting a process of encoding geometric information of the first point cloud block, and saving encoding resources.

By copying the attribute encoding information of the second point cloud block or the second point cloud block subjected to motion compensation to the reconstructed point cloud of the first point cloud block, attribute encoding information of the first point cloud block may be directly obtained by using the attribute encoding information of the second point cloud block, without encoding the attribute information of the first point cloud block, that is, a process of encoding the attribute information of the first point cloud block is omitted, and encoding resources are saved.

Step 902: The encoding side generates a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block, and the point cloud information includes at least one of geometric encoding information or attribute encoding information of a point cloud corresponding to the second point cloud block.

In this embodiment of this application, the first identification information can be expressed as, for example, PU_copy_flag, and the first identification information is used to identify whether the target point cloud frame uses a copy mode for prediction encoding. For example, when a value of the first identification information is set to 1, it is identified that the target point cloud frame uses the copy mode for prediction encoding, that is, the encoding side copies the point cloud information of the second point cloud block or the point cloud information of the second point cloud block subjected to motion compensation to the reconstructed point cloud of the first point cloud. For another example, when the value of the first identification information is set to 0, it is identified that the target point cloud frame does not use the copy mode for prediction encoding, that is, the encoding side does not copy the point cloud information of the second point cloud block or the point cloud information of the second point cloud block subjected to motion compensation to the reconstructed point cloud of the first point cloud. A purpose of motion compensation is to better match the second point cloud block of the reference point cloud frame with the first point cloud block of the target point cloud frame, thereby improving encoding quality.

In the solution of this embodiment of this application, an encoding side copies, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and the encoding side generates a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block. According to the solution, when a similarity between two point cloud blocks is high enough, point cloud information of one point cloud block is directly copied to a reconstructed point cloud of the other point cloud block, so that a process of encoding a point cloud of the other point cloud block is saved, encoding resources and encoding time can be saved on the premise of ensuring that point cloud quality does not fluctuate greatly, and encoding efficiency can be effectively improved.

Optionally, the copying, by an encoding side in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block includes:
obtaining, by the encoding side, a tree data structure corresponding to the target point cloud frame;
obtaining, by the encoding side, a size of a to-be-encoded node in a target level of the tree data structure; and
copying, by the encoding side in a case that a preset condition is met, and the similarity between the first point cloud block of the target point cloud frame and the second point cloud block of the reference point cloud frame is greater than or equal to the preset threshold, the point cloud information of the second point cloud block or the point cloud information of the second point cloud block subjected to motion compensation to the reconstructed point cloud of the first point cloud block, where the first point cloud block is a point cloud block corresponding to the to-be-encoded node in the target level, and the inter prediction skip mode refers to a mode in which point cloud information corresponding to a point cloud frame is not encoded, where
the preset condition includes one of the following:
second identification information indicates that the target point cloud frame enables an inter prediction skip mode; and
second identification information indicates that the target point cloud frame enables an inter prediction skip mode, and the size of the to-be-encoded node belongs to a preset range.

As an implementation, the tree data structure is octree. The encoding side performs octree split and occupancy code encoding processing on the target point cloud frame, to obtain an octree corresponding to the target point cloud frame.

The target level is a level in the tree structure, for example, an octree level in the octree.

The size of the to-be-encoded node may refer to a length of a side length corresponding to the to-be-encoded node.

The second identification information may be represented by gps.Skip_mode_flag. Optionally, when a value corresponding to the second identification information is set to 1, it indicates that the target point cloud frame enables the inter prediction skip mode, and when the value corresponding to the second identification information is set to 0, it indicates that the target point cloud frame does not enable the inter prediction skip mode.

For example, the preset range includes a first node size value and a second node size value. For example, the first node size value is represented by a maximum value of the copy mode (max_size_CopyPU), and the second node size value is represented by a minimum value of the copy mode (min_size_CopyPU). The size of the to-be-encoded node may be represented by a current node value (CurNode_size), and that the size of the to-be-encoded node belongs to the preset range may be represented as CurNode size≤max size_CopyPU&&CurNode_size≥min_size_CopyPU.

Because not all to-be-encoded nodes of image frames are suitable for encoding in the inter prediction skip mode, an image frame suitable for the inter prediction skip mode may be screened out by setting the second identification information. In addition, by setting the preset range, a to-be-encoded node with an appropriate size may be screened out to use the inter prediction skip mode, and flexibility of the to-be-encoded node that selects to use the inter prediction skip mode is improved through the second identification information and the preset range.

Optionally, the generating, by the encoding side, a target code stream based on first identification information includes:
generating, by the encoding side, the target code stream based on the first identification information and the second identification information; or
generating the target code stream based on the first identification information, the second identification information, and the preset range.

Herein, when the encoding side copies the point cloud information of the second point cloud block or the point cloud information of the second point cloud block subjected to motion compensation to the reconstructed point cloud of the first point cloud block, the first identification information and the second identification information (and the preset range) are encoded to obtain an encoded stream corresponding to the target point cloud frame, which skips a process of encoding the point cloud information of the first point cloud block, and saves encoding resources and encoding time.

Optionally, the obtaining, by the encoding side, a size of a to-be-encoded node in a target level of the tree data structure includes:

obtaining, by the encoding side in a case that third identification information indicates that a point cloud frame sequence enables an inter prediction skip mode, the size of the to-be-encoded node in the target level of the tree data structure, where the point cloud frame sequence includes the target point cloud frame.

In this embodiment of this application, the third identification information may be represented by Sps.Skip_mode_flag on. Optionally, when a value of the third identification information is set to 1, it indicates that the point cloud frame sequence enables the inter prediction skip mode, and when the value of the third identification information is set to 0, it indicates that the point cloud frame sequence does not enable the inter prediction skip mode.

Herein, the point cloud frame sequence using the inter prediction skip mode may be screened out by setting the third identification information, that is, flexibility of the point cloud frame sequence that selects to use the inter prediction skip mode is provided through the third identification information.

Optionally, the generating, by the encoding side, a target code stream based on first identification information includes:

generating, by the encoding side, the target code stream based on the first identification information, the second identification information, and the third identification information; or generating the target code stream based on the first identification information, the second identification information, the third identification information, and the preset range.

Herein, when the encoding side copies the point cloud information of the second point cloud block or the point cloud information of the second point cloud block subjected to motion compensation to the reconstructed point cloud of the first point cloud block, the first identification information, the second identification information, and the third identification information (and the preset range) are encoded to obtain an encoded stream corresponding to the target point cloud frame, which skips a process of encoding the point cloud information of the first point cloud block, and saves encoding resources and encoding time.

Optionally, the method in this embodiment of this application further includes:
obtaining a distortion rate of the first point cloud block relative to the second point cloud block or the second point cloud block subjected to motion compensation; and
obtaining, based on the distortion rate, a similarity between the first point cloud block and the second point cloud block or the second point cloud block subjected to motion compensation.

The distortion rate is inversely proportional to the similarity, that is, a smaller distortion rate indicates a higher similarity.

In this embodiment of this application, when a similarity of two point cloud blocks is high, that is, a difference is small, a distortion-code rate cost brought by using the inter prediction skip mode or not using the inter prediction skip mode may be evaluated by using a rate distortion cost. For example, if the distortion-code rate cost brought by using the inter prediction skip mode or not using the inter prediction skip mode is large, the value corresponding to the first identification information may be set to 0, that is, the first identification information indicates that the inter prediction skip mode is not used, and in this case, the target point cloud frame is encoded level by level by using the prediction entropy encoding mode; and if a rate distortion cost by using the inter prediction skip mode is small, the value corresponding to the first identification information is set to 1, that is, the first identification information indicates that the inter prediction skip mode is used. In this case, no encoding is required from a PU level node of the target point cloud frame down to a leaf node level, and the point cloud information of the second point cloud block or the second point cloud block subjected to motion compensation is directly copied to a corresponding reconstructed point cloud.

In addition, in this embodiment of this application, the similarity between the first point cloud block and the second point cloud block may be obtained based on a difference between a centroid offset of the first point cloud block and a centroid offset of the second point cloud block. Because the centroid is calculated based on distribution of points in the point cloud block, a smaller difference of the centroid offset between the first point cloud block and the second point cloud block indicates more similar distribution of points in the two point cloud blocks, and the similarity between the first point cloud block and the second point cloud block is higher.

Certainly, in this embodiment of this application, in addition to obtaining the similarity of two point cloud blocks based on the distortion rate and the centroid offset, the similarity of two point cloud blocks may also be obtained in other ways, which is not specifically limited herein.

In addition, in real-time dynamic point cloud transmission, the inter prediction skip mode may also be used in scenarios with high encoding delay requirements. The prediction entropy encoding mode is a general inter prediction encoding mode. When processing the to-be-encoded node (hereinafter referred to as the node for short) of the current point cloud frame, different processing is performed based on a size relationship between the node and the LPU: when a size of the node of the current point cloud frame>a size of the node of the LPU, the reference point cloud is directly used as prediction information to encode the current frame because there is no motion vector available for motion compensation of the reference frame point cloud; and when a size of the node of the current frame≤the size of the node of the LPU, it is split based on a PU mode. Firstly, it is determined whether the PU needs to continue to be split downward. If the PU stops splitting downward, the current frame is encoded by using the motion compensation point cloud as prediction information. Conversely, if the PU continues to be split downward, the reference point cloud is directly used as prediction information to encode the current frame. Finally, a constructed inter context is merged with intra context information of the node of the current frame, and a merged context is input into the entropy encoder to encode the point cloud of the current point cloud frame.

Optionally, the method in this embodiment of this application further includes:
in a case that the size of the to-be-encoded node in the target level of the tree data structure corresponding to the target point cloud frame is the same as a size of a to-be-encoded node corresponding to a largest prediction unit (LPU), and the reference point cloud frame meets a condition for enabling local motion estimation, performing motion estimation on the first point cloud block, determining a second point cloud block matching the first point cloud block in the reference point cloud frame, and determining a motion vector of the first point cloud block relative to the second point cloud block; and
performing motion compensation on the second point cloud block based on the motion vector, to obtain the second point cloud block subjected to motion compensation.

In this embodiment of this application, motion compensation is performed on the second point cloud block, so that the second point cloud block is more matched with the first point cloud block, the point cloud information of the second point cloud block is more matched with the first point cloud block, and encoding quality of the point cloud can be effectively improved.

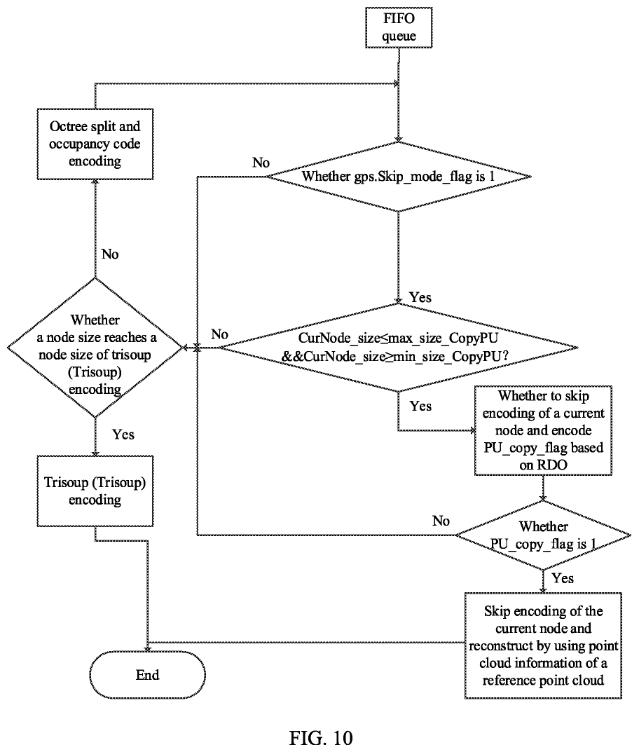

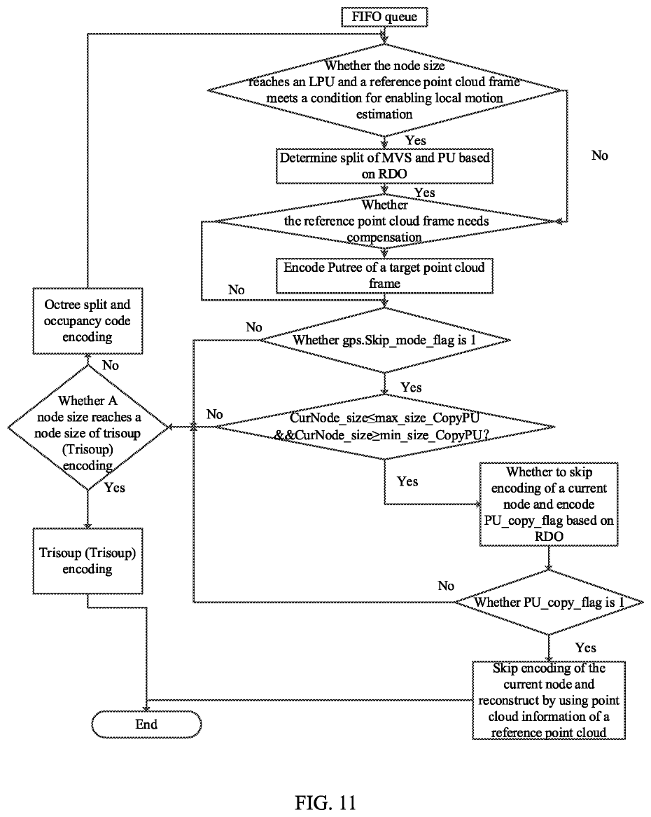

The encoding method in this embodiment of this application is described below with reference to FIG. 10 and FIG. 11.

In this embodiment of this application, octree split and occupancy code encoding processing are first performed on the target point cloud frame, to obtain an octree corresponding to the target point cloud frame. When performing PU-based inter prediction encoding based on the octree, the following steps may be followed.

Step 1: Determine whether Sps.Skip_mode_flag on is 1, if it is 1, it indicates that the point cloud frame sequence enables the inter prediction skip mode, and if it is 0, it indicates that the point cloud frame sequence disables the inter prediction skip mode.

Step 2: When Sps.Skip_mode_flag on is 1, slice (slice) the current point cloud frame.

Step 1 and step 2 are optional steps.

Step 3: When Sps.Skip_mode_flag on is 1, based on each slice of point cloud, read all nodes at each level (0≤depth<maxDepth) of a current slice from a first input first output (First Input First Output, FIFO) queue of the octree data structure. maxDepth is a maximum depth of octree split for the point cloud of the current frame (the number of levels from a root node to a leaf node).

Step 4: Determine whether gps.Skip_mode_flag is 1, if it is 1, it indicates that the target point cloud frame (such as the current point cloud frame) enables the inter prediction skip mode, and if it is 0, it indicates that the target point cloud frame disables the inter prediction skip mode.

If gps.Skip_mode_flag is 1, it is determined whether the size of the current to-be-encoded node meets a qualification condition of Skip_size. That is, only a node that satisfies CurNode_size≤max_size_CopyPU&&CurNode_size≥min_size_CopyPU is allowed to use the inter prediction skip (SKip) mode. When such a node is encoded, the encoder may evaluate, through the rate distortion cost, a distortion-code rate cost brought by using or not using the mode. If a rate distortion cost for the current node to use the copy mode is high, it is flagged that the current node does not use the copy mode (PU_copy_flag=0), and in this case, the prediction entropy encoding mode is used to encode a node level of the current frame; and if the rate distortion cost for the current node to use the copy mode is low, it is flagged that the current node uses the inter prediction skip mode (PU_copy_flag=1). In this case, the current node does not need to be encoded, and the reference block or the compensated reference block is directly copied to the reconstructed point cloud.

If gps.Skip_mode_flag is 0, the prediction entropy encoding mode is used to encode the node level of the current frame.

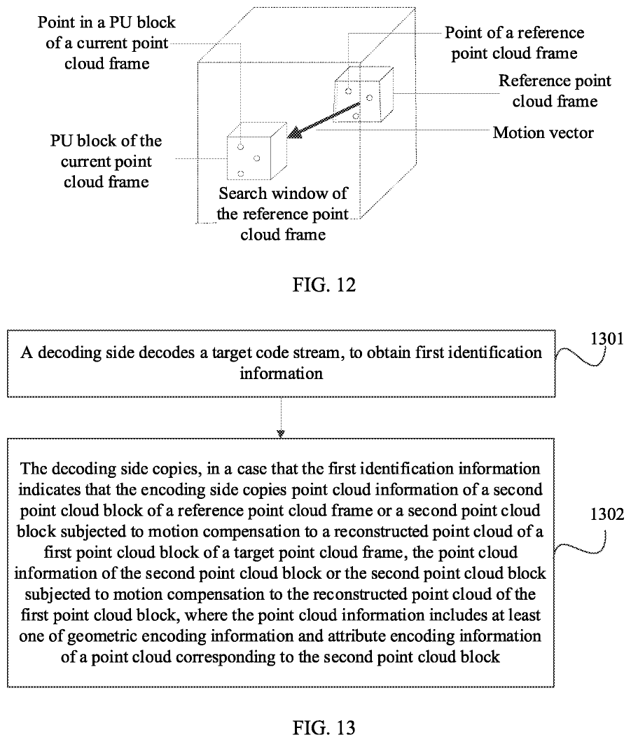

In addition, as shown in FIG. 11, for a node in a depth level, the following determination may be made. A determination condition is that a node size reaches a size of an LPU, and a reference point cloud frame meets the condition for enabling local motion estimation (for example, the number of points in the reference point cloud frame is greater than 50). If the condition is met, an operation of split or not split may be tried for each PU, and motion estimation is performed on each PU, to determine a matching position of the current PU in the reference frame and a corresponding motion vector (as shown in FIG. 12), to find an optimal motion vector in different PU split modes for motion compensation. Each PU includes a PU at the current level and all sub-PUs that may be split iteratively. Inter prediction is performed for each PU. Based on a best matching motion vector, various prediction modes are tried, such as an inter Skip mode and a prediction entropy encoding mode, to predict the current PU. A rate distortion optimization technology is used to select an optimal PU split mode, motion vector, and prediction encoding mode. A goal of optimization is to minimize encoding distortion and maintain an appropriate bit rate. For each PU, different split modes, motion vectors, and prediction encoding modes are tried, and a distortion and a bit rate caused are calculated. Then, by comparing distortion-bit rate trade offs of different options, a PU split mode, a motion vector, and a prediction encoding mode with best performance are selected. Finally, based on the selected PU split mode, motion vector, and prediction encoding mode, optimal PU split, motion compensation, and prediction encoding are performed.

Step 5: Finally, determine whether the node size of the current depth level reaches a node size of trisoup encoding, if yes, trisoup encoding is performed, otherwise, return to the first step, and iterate circularly until all nodes are encoded.

With the current ges v3.0_rcl as reference or anchor (anchor), compression gains generated by using the solution of this application are shown in Table 1. Cat2-A, Cat2-B, and Cat2-C are sequence names, C2 represents a point cloud compression test condition, luminance (Luma), chroma blue (Chroma Cb) and chroma red (Chroma Cr) represent three components of color, and D1 and D2 represent two different geometric quality distortion evaluation parameters of point cloud. When D1 and D2 are negative values, it indicates that under the test condition C2, comprehensive quality of point cloud generated when encoding the point cloud by using the solution of this application is higher than that of the existing technical solutions.

TABLE 1

| | | Chroma | Chroma | | |
|---|---|---|---|---|---|
| C2 | Luma | Cb | Cr | D1 | D2 |
| Cat2-A gain | 0.8% | −0.2% | 0.2% | −1.3% | −4.2% |
| Cat2-B gain | 1.7% | 0.9% | 1.0% | −7.9% | −11.9% |
| Cat2-C gain | 1.1% | 0.3% | 0.1% | −10.0% | −64.7% |
| Overall average gain | 1.0% | 0.1% | 0.3% | −4.7% | −22.6% |
| (overall average) | | | | | |

In the solution of this embodiment of this application, an encoding side copies, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and the encoding side generates a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block. According to the solution, when a similarity between two point cloud blocks is high enough, point cloud information of one point cloud block is directly copied to a reconstructed point cloud of the other point cloud block, so that a process of encoding a point cloud of the other point cloud block is saved, encoding resources and encoding time can be saved on the premise of ensuring that point cloud quality does not fluctuate greatly, and encoding efficiency can be effectively improved.

As shown in FIG. 13, an embodiment of this application further provides a decoding method, including the following steps.

Step 1301: A decoding side decodes a target code stream, to obtain first identification information.

The first identification information has been described in detail in the method embodiment of the encoding side. Details are not described herein again.

Step 1302: The decoding side copies, in a case that the first identification information indicates that the encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block, where the point cloud information includes at least one of geometric encoding information or attribute encoding information of a point cloud corresponding to the second point cloud block.

In this embodiment of this application, a decoding side decodes a target code stream, to obtain first identification information; and the decoding side copies, in a case that the first identification information indicates that the encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block. That is, the point cloud information of the first point cloud block and the point cloud information of the second point cloud block are the same, and the decoding side may obtain decoding information of the first point cloud block and decoding information of the second point cloud block by decoding only the point cloud information of the second point cloud block during decoding, thereby saving decoding resources and decoding time, and improving decoding efficiency.

Optionally, the decoding, by a decoding side, a target code stream, to obtain first identification information includes:
decoding, by the decoding side, a first code stream in the target code stream, to obtain second identification information;
obtaining, by the decoding side, a size of a to-be-encoded node in a target level of a tree data structure corresponding to the target point cloud frame; and
decoding a second code stream in the target code stream in a case that the second identification information indicates that the target point cloud frame enables an inter prediction skip mode, and the size of the to-be-encoded node belongs to a preset range, to obtain the first identification information, where the inter prediction skip mode refers to a mode in which point cloud information corresponding to a point cloud frame is not encoded.

Herein, the decoding side may obtain the preset range from the first code stream through decoding, and the decoding side may also directly obtain the preset range configured or set in advance.

Optionally, the first code stream further includes third identification information; and
the obtaining a size of a to-be-encoded node in a target level of the tree data structure includes:
obtaining, in a case that the third identification information indicates that a point cloud frame sequence enables the inter prediction skip mode, the size of the to-be-encoded node in the target level of the tree data structure, where the point cloud frame sequence includes the target point cloud frame.

Optionally, the method further includes:
in a case that the size of the to-be-encoded node in the target level is the same as a size of a node corresponding to a largest prediction unit (LPU), and the reference point cloud frame meets a condition for enabling local motion estimation, based on the target code stream, obtaining a second point cloud block matching the first point cloud block in the reference point cloud frame, and obtaining a motion vector of the first point cloud block relative to the second point cloud block; and
performing motion compensation on the second point cloud block based on the motion vector, to obtain the second point cloud block subjected to motion compensation.

In this embodiment of this application, when the decoding side performs prediction unit (PU)-based inter prediction decoding based on octree split, the following steps may be followed.

Step 1: Parse whether Sps.Skip_mode_flag on is 1 in frame-level syntax elements, if it is 1, it indicates that the point cloud frame sequence enables the inter prediction skip mode, and if it is 0, it indicates that the point cloud frame sequence disables the inter prediction skip mode.

Step 2: Parse, based on the slice of point cloud, all pieces of node occupancy information of each level (0≤depth<maxDepth) of the current slice. maxDepth is a maximum depth of octree split for the point cloud of the current frame (levels from a root node to a leaf node).

Step 3: Parse whether current gps.Skip_mode_flag is 1, if it is 1, it indicates that the target point cloud frame (such as the current point cloud frame) enables the inter prediction skip mode, and if it is 0, it indicates that the target point cloud frame disables the inter prediction skip mode.

If gps.Skip_mode_flag is 1, it is determined whether the size of the current node meets a qualification condition of Skip_size. That is, only a node that satisfies CurNode_size≤max_size_CopyPU&&CurNode_size≥min_size_CopyPU is allowed to use the inter prediction skip (SKip) mode. When such a node is decoded, it is parsed whether PU_split_flag of the current node is 0. If it is 0, the prediction entropy decoding mode is used to decode nodes of the current frame level by level; and if it is 1, the current node does not need to be decoded, and the reference block or the compensated reference block is directly copied to the reconstructed point cloud.

If gps.Skip_mode_flag is 0, the prediction entropy decoding mode is used to decode the node level of the current frame.

In addition, for the node in the depth level, the following determination is further made. A determination condition is that a node size reaches a size of an LPU, and a reference point cloud frame meets the condition for enabling local motion estimation. If the condition is met, operation is performed for each PU. If the PU is less than or equal to a size of sps minimum PU (sps_minPU_size), it is inferred that PU_split_flag is 0; and otherwise, a PU level split flag: PU_split_flag is decoded. If PU_split_flag is false, motion compensation is performed on a PU of the current level; and if PU_split_flag is true, motion compensation is performed on a node in which PU_split_flag of a finally iteratively split PU is false and in which the PU is greater than the minimum PU size. For a PU that needs motion compensation, three direction values of motion vector are obtained through decoding, and the three direction values are used to perform motion compensation on the PU. Decode a PU level PU_copy_flag to determine the prediction mode. If PU_copy_flag is true, it indicates that the decoding side selects the copy mode. A reference point is directly copied to a reconstructed point cloud, and no subsequent decoding operation is needed in this case. If PU_copy_flag is false, the node of the current frame needs to be decoded based on inter information decoded by the PU with reference to an intra context.

Step 4: Finally, determine whether the node size of the current depth level reaches a node size of trisoup decoding, if yes, trisoup decoding is performed, otherwise, return to the first step, and iterate circularly until all nodes are decoded.

It should be noted that the decoding method performed by the decoding side is a decoding method corresponding to the encoding method performed by the encoding side, and details are not described herein again.

The encoding method provided in this embodiment of this application may be executed by an encoding apparatus. In this embodiment of this application, an example in which the encoding apparatus performs the encoding method is used to describe the encoding apparatus provided in this embodiment of this application.

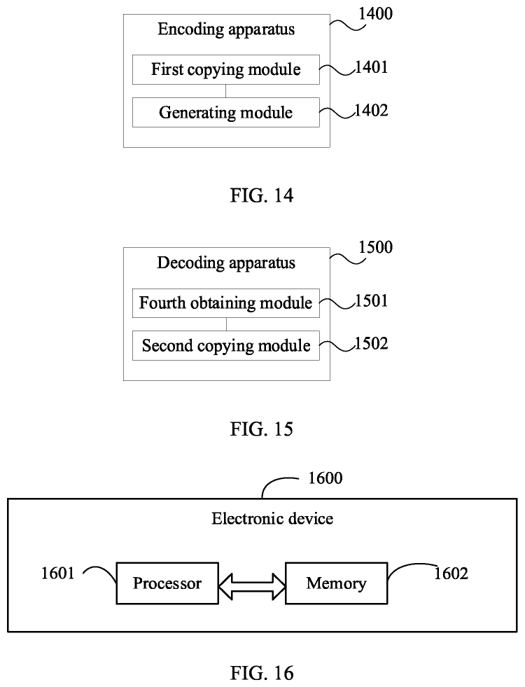

As shown in FIG. 14, an embodiment of this application provides an encoding apparatus 1400, including:
a first copying module 1401, configured to copy, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and
a generating module 1402, configured to generate a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block, and the point cloud information includes at least one of geometric encoding information or attribute encoding information of a point cloud corresponding to the second point cloud block.

Optionally, the first copying module includes:
a first obtaining submodule, configured to obtain a tree data structure corresponding to the target point cloud frame;
a second obtaining submodule, configured to obtain a size of a to-be-encoded node in a target level of the tree data structure; and
a copying submodule, configured to copy, in a case that a preset condition is met, and the similarity between the first point cloud block of the target point cloud frame and the second point cloud block of the reference point cloud frame is greater than or equal to the preset threshold, the point cloud information of the second point cloud block or the point cloud information of the second point cloud block subjected to motion compensation to the reconstructed point cloud of the first point cloud block, where the first point cloud block is a point cloud block corresponding to the to-be-encoded node in the target level, and the inter prediction skip mode refers to a mode in which point cloud information corresponding to a point cloud frame is not encoded, where
the preset condition includes one of the following:
second identification information indicates that the target point cloud frame enables an inter prediction skip mode; and
second identification information indicates that the target point cloud frame enables an inter prediction skip mode, and the size of the to-be-encoded node belongs to a preset range.

Optionally, the generating module is configured to: generate the target code stream based on the first identification information and the second identification information; or

generate the target code stream based on the first identification information, the second identification information, and the preset range.

Optionally, the second obtaining submodule is configured to obtain, in a case that third identification information indicates that a point cloud frame sequence enables the inter prediction skip mode, the size of the to-be-encoded node in the target level of the tree data structure, where the point cloud frame sequence includes the target point cloud frame.

Optionally, the generating module is configured to: generate the target code stream based on the first identification information, the second identification information, and the third identification information; or generate the target code stream based on the first identification information, the second identification information, the third identification information, and the preset range.

Optionally, the apparatus in this embodiment of this application further includes:
a first obtaining module, configured to obtain a distortion rate of the first point cloud block relative to the second point cloud block or the second point cloud block subjected to motion compensation; and
a second obtaining module, configured to obtain, based on the distortion rate, a similarity between the first point cloud block and the second point cloud block or the second point cloud block subjected to motion compensation.

Optionally, the apparatus in this embodiment of this application further includes:
a determining module, configured to: in a case that the size of the to-be-encoded node in the target level of the tree data structure corresponding to the target point cloud frame is the same as a size of a to-be-encoded node corresponding to a largest prediction unit (LPU), and the reference point cloud frame meets a condition for enabling local motion estimation, perform motion estimation on the first point cloud block, determine a second point cloud block matching the first point cloud block in the reference point cloud frame, and determine a motion vector of the first point cloud block relative to the second point cloud block; and
a third obtaining module, configured to perform motion compensation on the second point cloud block based on the motion vector, to obtain the second point cloud block subjected to motion compensation.

In this embodiment of this application, an encoding side copies, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and the encoding side generates a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block. According to the solution, when a similarity between two point cloud blocks is high enough, point cloud information of one point cloud block is directly copied to a reconstructed point cloud of the other point cloud block, so that a process of encoding a point cloud of the other point cloud block is saved, encoding resources and encoding time can be saved on the premise of ensuring that point cloud quality does not fluctuate greatly, and encoding efficiency can be effectively improved.

The encoding apparatus provided in this embodiment of this application can implement the processes implemented in the method embodiments from FIG. 9 to FIG. 12, and a same technical effect can be achieved. To avoid repetition, details are not described herein again.

As shown in FIG. 15, an embodiment of this application provides a decoding apparatus 1500, including:
a fourth obtaining module 1501, configured to decode a target code stream, to obtain first identification information; and
a second copying module 1502, configured to copy, in a case that the first identification information indicates that an encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block, where the point cloud information includes at least one of geometric encoding information or attribute encoding information of a point cloud corresponding to the second point cloud block.

Optionally, the fourth obtaining module includes:
a third obtaining submodule, configured to decode a first code stream in the target code stream, to obtain second identification information;
a fourth obtaining submodule, configured to obtain a size of a to-be-encoded node in a target level of a tree data structure corresponding to the target point cloud frame; and
a fifth obtaining submodule, configured to decode a second code stream in the target code stream in a case that the second identification information indicates that the target point cloud frame enables an inter prediction skip mode, and the size of the to-be-encoded node belongs to a preset range, to obtain the first identification information, where the inter prediction skip mode refers to a mode in which point cloud information corresponding to a point cloud frame is not encoded.

Optionally, the first code stream further includes third identification information; and

the fourth obtaining submodule is configured to obtain, in a case that the third identification information indicates that a point cloud frame sequence enables the inter prediction skip mode, the size of the to-be-encoded node in the target level of the tree data structure, where the point cloud frame sequence includes the target point cloud frame.

Optionally, the apparatus in this embodiment of this application further includes:
a fifth obtaining module, configured to: in a case that the size of the to-be-encoded node in the target level is the same as a size of a node corresponding to a largest prediction unit (LPU), and the reference point cloud frame meets a condition for enabling local motion estimation, based on the target code stream, obtain a second point cloud block matching the first point cloud block in the reference point cloud frame, and obtain a motion vector of the first point cloud block relative to the second point cloud block; and
a sixth obtaining module, configured to perform motion compensation on the second point cloud block based on the motion vector, to obtain the second point cloud block subjected to motion compensation.

In this embodiment of this application, a decoding side decodes a target code stream, to obtain first identification information; and the decoding side copies, in a case that the first identification information indicates that the encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block. That is, the point cloud information of the first point cloud block and the point cloud information of the second point cloud block are the same, and the decoding side may obtain decoding information of the first point cloud block and decoding information of the second point cloud block by decoding only the point cloud information of the second point cloud block during decoding, thereby saving decoding resources and decoding time, and improving decoding efficiency.

As shown in FIG. 16, an embodiment of this application further provides an electronic device 1600, including a processor 1601 and a memory 1602, and the memory 1602 stores a program or an instruction that can be run on the processor 1601. For example, in a case that the electronic device 1600 is an encoding side device, when the program or the instruction is executed by the processor 1601, the steps of the encoding method embodiment are implemented, and a same technical effect can be achieved. When the electronic device 1600 is a decoding side device, and the program or the instruction is executed by the processor 1601, the steps of the decoding method embodiment are implemented, and a same technical effect can be achieved. To avoid repetition, details are not described herein again. Optionally, the memory 1602 may be the memory 102 or the memory 113 in the embodiment shown in FIG. 1, and the processor 1601 may realize functions of the encoder 200 or the decoder 300 in the embodiment shown in FIG. 1 to FIG. 3.

An embodiment of this application further provides an electronic device, including: a memory, configured to store video data; and a processing circuit, configured to implement the steps of the encoding method embodiment or the decoding method embodiment. Optionally, the memory may be the memory 102 or the memory 113 in the embodiment shown in FIG. 1, and the processing circuit may realize functions of the encoder 200 or the decoder 300 in the embodiment shown in FIG. 1 to FIG. 3.

An embodiment of this application further provides an electronic device, including a processor and a communication interface. The communication interface is coupled to the processor, and the processor is configured to run a program or an instruction to implement the steps of the method embodiment shown in FIG. 9 or FIG. 13. The device embodiment is corresponding to the method embodiment, each implementation process and implementation of the method embodiment can be applied to the terminal embodiment, and a same technical effect can be achieved.

The electronic device may be a terminal, or a device other than the terminal, such as a server or a network attached storage (Network Attached Storage, NAS).

The terminal may be a terminal side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (Ultra-mobile Personal Computer, UMPC), a mobile Internet device (Mobile Internet Device, MID), an augmented reality (Augmented Reality, AR) or virtual reality (Virtual Reality, VR) device, a mixed reality (mixed reality, MR) device, a robot, a wearable device (Wearable Device), a flight vehicle (flight vehicle), vehicle user equipment (Vehicle User Equipment, VUE), ship-borne equipment, pedestrian user equipment (Pedestrian User Equipment, PUE), smart household (household devices with wireless communication functions, such as a refrigerator, a television, a washing machine, or furniture), a game console, a personal computer (Personal Computer, PC), a teller machine, or a self-service machine. The wearable device includes: a smart watch, a smart band, a smart headset, smart glasses, smart jewelry (a smart bracelet, a smart hand chain, a smart ring, a smart necklace, a smart bangle, a smart anklet, and the like), a smart wristband, smart clothing, and the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal is not limited in the embodiments of this application.

The server may be an independent physical server, or may be a server cluster or a distributed system including a plurality of physical servers, or may be a cloud server, and the cloud server may provide a cloud service, a cloud database, cloud computing, a cloud function, cloud storage, a network service, cloud communication, a middleware service, a domain name service, a security service, a content delivery network (Content Delivery Network, CDN), or a cloud computing service based on big data and an artificial intelligence platform.

For example, the electronic device may include, but is not limited to, the type of the source device 100 or the destination device 110 shown in FIG. 1.

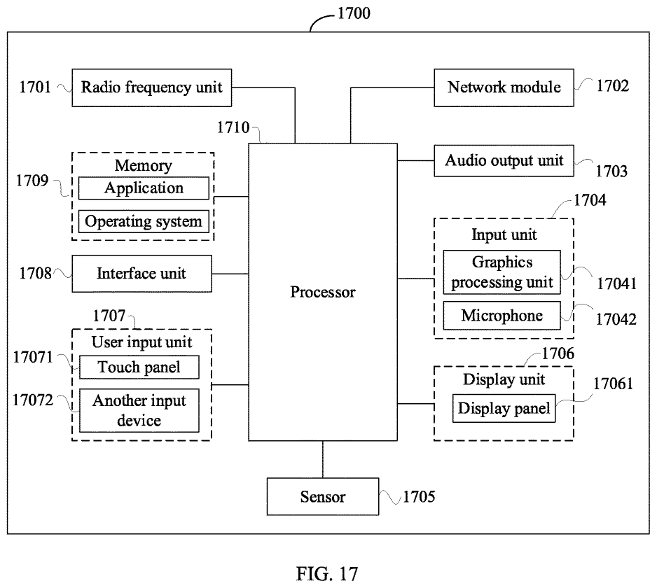

In an example in which the electronic device is a terminal, FIG. 17 is a schematic diagram of a hardware structure of a terminal according to an embodiment of this application.

The terminal 1700 includes but is not limited to at least a part of components such as a radio frequency unit 1701, a network module 1702, an audio output unit 1703, an input unit 1704, a sensor 1705, a display unit 1706, a user input unit 1707, an interface unit 1708, a memory 1709, and a processor 1710.

It may be understood by a person skilled in the art that the terminal 1700 may further include a power supply (such as a battery) that supplies power to each component. The power supply may be logically connected to the processor 1710 by using a power management system, to implement functions such as charging, discharging, and power consumption management by using the power management system. The terminal structure shown in FIG. 17 constitutes no limitation on the terminal, and the terminal may include more or fewer components than those shown in the figure, or combine some components, or have different component arrangements. Details are not described herein.

It should be understood that in this embodiment of this application, the input unit 1704 may include a graphics processing unit (Graphics Processing Unit, GPU) 17041 and a microphone 17042. The graphics processing unit 17041 processes image data of a static picture or a video obtained by an image capture apparatus (for example, a camera) in a video capture mode or an image capture mode, or may process the obtained point cloud data. The display unit 1706 may include a display panel 17061, and the display panel 17061 may be configured in a form of a liquid crystal display, an organic light-emitting diode, or the like. The user input unit 1707 includes at least one of a touch panel 17071 or another input device 17072. The touch panel 17071 is also referred to as a touchscreen. The touch panel 17071 may include two parts: a touch detection apparatus and a touch controller. The another input device 17072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1701 may transmit the downlink data to the processor 1710 for processing. In addition, the radio frequency unit 1701 may send uplink data to the network side device. Generally, the radio frequency unit 1701 includes but is not limited to an antenna, an amplifier, a transceiver, a coupler, a low noise amplifier, a duplexer, and the like.

The memory 1709 may be configured to store a software program or an instruction and various data. The memory 1709 may mainly include a first storage area for storing a program or an instruction and a second storage area for storing data. The first storage area may store an operating system, and an application or an instruction required by at least one function (for example, a sound playing function or an image playing function). In addition, the memory 1709 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synch link dynamic random access memory (Synch link DRAM, SLDRAM), and a direct rambus random access memory (Direct Rambus RAM, DRRAM). The memory 1709 in this embodiment of this application includes but is not limited to these memories and any memory of another proper type.

The processor 1710 may include one or more processing units. Optionally, an application processor and a modem processor are integrated into the processor 1710. The application processor mainly processes an operating system, a user interface, an application, or the like. The modem processor mainly processes a wireless communication signal, for example, a baseband processor. It may be understood that, alternatively, the modem processor may not be integrated into the processor 1710.

In an embodiment of this application, the processor 1710 is configured to: copy, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and

generate a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block, and the point cloud information includes at least one of geometric encoding information or attribute encoding information of a point cloud corresponding to the second point cloud block.

Optionally, the processor 1710 is further configured to:
obtain a tree data structure corresponding to the target point cloud frame;
obtain a size of a to-be-encoded node in a target level of the tree data structure; and
copy, in a case that a preset condition is met, and the similarity between the first point cloud block of the target point cloud frame and the second point cloud block of the reference point cloud frame is greater than or equal to the preset threshold, the point cloud information of the second point cloud block or the point cloud information of the second point cloud block subjected to motion compensation to the reconstructed point cloud of the first point cloud block, where the first point cloud block is a point cloud block corresponding to the to-be-encoded node in the target level, and the inter prediction skip mode refers to a mode in which point cloud information corresponding to a point cloud frame is not encoded, where
the preset condition includes one of the following:
second identification information indicates that the target point cloud frame enables an inter prediction skip mode; and
second identification information indicates that the target point cloud frame enables an inter prediction skip mode, and the size of the to-be-encoded node belongs to a preset range.

Optionally, the processor 1710 is further configured to:
generate the target code stream based on the first identification information and the second identification information; or
generate the target code stream based on the first identification information, the second identification information, and the preset range.

Optionally, the processor 1710 is further configured to:

obtain, in a case that the third identification information indicates that a point cloud frame sequence enables the inter prediction skip mode, the size of the to-be-encoded node in the target level of the tree data structure, where the point cloud frame sequence includes the target point cloud frame.

Optionally, the processor 1710 is further configured to:

generate the target code stream based on the first identification information, the second identification information, and the third identification information; or generate the target code stream based on the first identification information, the second identification information, the third identification information, and the preset range.

Optionally, the processor 1710 is further configured to:
obtain a distortion rate of the first point cloud block relative to the second point cloud block or the second point cloud block subjected to motion compensation; and
obtain, based on the distortion rate, a similarity between the first point cloud block and the second point cloud block or the second point cloud block subjected to motion compensation.

Optionally, the processor 1710 is further configured to:
in a case that the size of the to-be-encoded node in the target level of the tree data structure corresponding to the target point cloud frame is the same as a size of a to-be-encoded node corresponding to a largest prediction unit (LPU), and the reference point cloud frame meets a condition for enabling local motion estimation, perform motion estimation on the first point cloud block, determine a second point cloud block matching the first point cloud block in the reference point cloud frame, and determine a motion vector of the first point cloud block relative to the second point cloud block; and
perform motion compensation on the second point cloud block based on the motion vector, to obtain the second point cloud block subjected to motion compensation.

In this embodiment of this application, an encoding side copies, in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and the encoding side generates a target code stream based on first identification information, where the first identification information is used to indicate to a decoding side that the encoding side copies the point cloud information of the second point cloud block or the point cloud information of the second point cloud block subjected to motion compensation to the reconstructed point cloud of the first point cloud block. According to the solution, when a similarity between two point cloud blocks is high enough, point cloud information of one point cloud block is directly copied to a reconstructed point cloud of the other point cloud block, so that a process of encoding a point cloud of the other point cloud block is saved, encoding resources and encoding time can be saved on the premise of ensuring that point cloud quality does not fluctuate greatly, and encoding efficiency can be effectively improved.

It can be understood that for the implementation process of each implementation given in this embodiment, refer to the related description of the encoding method embodiment, and a same or corresponding technical effect is achieved. To avoid repetition, details are not described herein again.

In an embodiment of this application, the processor 1710 is configured to:
decode a target code stream, to obtain first identification information; and
copy, in a case that the first identification information indicates that an encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block, where the point cloud information includes at least one of geometric encoding information or attribute encoding information of a point cloud corresponding to the second point cloud block.

Optionally, the processor 1710 is further configured to:
decode a first code stream in the target code stream, to obtain second identification information;
obtain a size of a to-be-encoded node in a target level of the tree data structure; and
decode a second code stream in the target code stream in a case that the second identification information indicates that the target point cloud frame enables an inter prediction skip mode, and the size of the to-be-encoded node belongs to a preset range, to obtain the first identification information, where the inter prediction skip mode refers to a mode in which point cloud information corresponding to a point cloud frame is not encoded.

Optionally, the first code stream further includes third identification information; and
the processor 1710 is further configured to:
obtain, in a case that the third identification information indicates that a point cloud frame sequence enables the inter prediction skip mode, the size of the to-be-encoded node in the target level of the tree data structure, where the point cloud frame sequence includes the target point cloud frame.

Optionally, the processor 1710 is further configured to:
in a case that the size of the to-be-encoded node in the target level is the same as a size of a node corresponding to a largest prediction unit (LPU), and the reference point cloud frame meets a condition for enabling local motion estimation, based on the target code stream, obtain a second point cloud block matching the first point cloud block in the reference point cloud frame, and obtain a motion vector of the first point cloud block relative to the second point cloud block; and
perform motion compensation on the second point cloud block based on the motion vector, to obtain the second point cloud block subjected to motion compensation.

It can be understood that for the implementation process of each implementation given in this embodiment, refer to the related description of the decoding method embodiment, and a same or corresponding technical effect is achieved. To avoid repetition, details are not described herein again.

An embodiment of this application further provides a readable storage medium. The readable storage medium stores a program or an instruction, and the program or the instruction is executed by a processor to implement the processes of the encoding method embodiment or the decoding method embodiment, and a same technical effect can be achieved. To avoid repetition, details are not described herein again.

The processor is a processor in the terminal in the foregoing embodiments. The readable storage medium includes a computer-readable storage medium, such as a ROM, a RAM, a magnetic disk, or an optical disc. In some examples, the readable storage medium may be a non-transient readable storage medium.

An embodiment of this application further provides a chip, the chip includes a processor and a communication interface, the communication interface is coupled to the processor, and the processor is configured to run a program or an instruction to implement the processes of the encoding method embodiment or the decoding method embodiment, and a same technical effect can be achieved. To avoid repetition, details are not described herein again.

It should be understood that the chip mentioned in this embodiment of this application may be a system-level chip (also referred to as a system chip, a chip system, or an on-chip system chip), an independent display chip, or the like.

An embodiment of this application further provides a computer program/program product. The computer program/program product is stored in a storage medium, and the computer program/program product is executed by at least one processor to implement the processes of the encoding method embodiment or the decoding method embodiment, and a same technical effect can be achieved. To avoid repetition, details are not described herein again.

An embodiment of this application further provides a codec system, including an encoding side device and a decoding side device. The encoding side device may be configured to perform the steps of the encoding method, and the decoding side device may be configured to perform the steps of the decoding method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the implementations of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by a computer software product and a required universal hardware platform, or certainly may be implemented by using hardware. The computer software product is stored in a storage medium (for example, a ROM, a RAM, a magnetic disk, or an optical disc), and includes several instructions for instructing a terminal or a network side device to perform the method described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms of implementations without departing from the purpose of this application and the protection scope of the claims, all of which fall within the protection of this application.

1. An encoding method, comprising:
copying, by an encoding side in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block; and
generating, by the encoding side, a target code stream based on first identification information, wherein the first identification information is used to indicate to a decoding side that the encoding side copies the point cloud information of the second point cloud block or the point cloud information of the second point cloud block subjected to motion compensation to the reconstructed point cloud of the first point cloud block, and the point cloud information comprises at least one of geometric encoding information or attribute encoding information of a point cloud corresponding to the second point cloud block.

2. The method according to claim 1, wherein the copying, by an encoding side in a case that a similarity between a first point cloud block of a target point cloud frame and a second point cloud block of a reference point cloud frame is greater than or equal to a preset threshold, point cloud information of the second point cloud block or point cloud information of a second point cloud block subjected to motion compensation to a reconstructed point cloud of the first point cloud block comprises:
obtaining, by the encoding side, a tree data structure corresponding to the target point cloud frame;
obtaining, by the encoding side, a size of a to-be-encoded node in a target level of the tree data structure; and
copying, by the encoding side in a case that a preset condition is met, and the similarity between the first point cloud block of the target point cloud frame and the second point cloud block of the reference point cloud frame is greater than or equal to the preset threshold, the point cloud information of the second point cloud block or the point cloud information of the second point cloud block subjected to motion compensation to the reconstructed point cloud of the first point cloud block, wherein the first point cloud block is a point cloud block corresponding to the to-be-encoded node in the target level, wherein
the preset condition comprises one of the following:
second identification information indicates that the target point cloud frame enables an inter prediction skip mode; and
second identification information indicates that the target point cloud frame enables an inter prediction skip mode, and the size of the to-be-encoded node belongs to a preset range, wherein the inter prediction skip mode refers to a mode in which point cloud information corresponding to a point cloud frame is not encoded.

3. The method according to claim 2, wherein the generating, by the encoding side, a target code stream based on first identification information comprises:
generating, by the encoding side, the target code stream based on the first identification information and the second identification information; or
generating, by the encoding side, the target code stream based on the first identification information, the second identification information, and the preset range.

4. The method according to claim 2, wherein the obtaining, by the encoding side, a size of a to-be-encoded node in a target level of the tree data structure comprises:
obtaining, by the encoding side in a case that third identification information indicates that a point cloud frame sequence enables an inter prediction skip mode, the size of the to-be-encoded node in the target level of the tree data structure, wherein the point cloud frame sequence comprises the target point cloud frame.

5. The method according to claim 4, wherein the generating, by the encoding side, a target code stream based on first identification information comprises:
generating, by the encoding side, the target code stream based on the first identification information, the second identification information, and the third identification information; or
generating, by the encoding side, the target code stream based on the first identification information, the second identification information, the third identification information, and the preset range.

6. The method according to claim 1, further comprising:
obtaining a distortion rate of the first point cloud block relative to the second point cloud block or the second point cloud block subjected to motion compensation; and
obtaining, based on the distortion rate, a similarity between the first point cloud block and the second point cloud block or the second point cloud block subjected to motion compensation.

7. The method according to claim 1, wherein the method further comprises:
in a case that the size of the to-be-encoded node in the target level of the tree data structure corresponding to the target point cloud frame is the same as a size of a to-be-encoded node corresponding to a largest prediction unit (LPU), and the reference point cloud frame meets a condition for enabling local motion estimation, performing motion estimation on the first point cloud block, determining a second point cloud block matching the first point cloud block in the reference point cloud frame, and determining a motion vector of the first point cloud block relative to the second point cloud block; and
performing motion compensation on the second point cloud block based on the motion vector, to obtain the second point cloud block subjected to motion compensation.

8. A decoding method, comprising:
decoding, by a decoding side, a target code stream, to obtain first identification information; and
copying, by the decoding side in a case that the first identification information indicates that an encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block, wherein the point cloud information comprises at least one of geometric encoding information or attribute encoding information of a point cloud corresponding to the second point cloud block.

9. The method according to claim 8, wherein the decoding, by a decoding side, a target code stream, to obtain first identification information comprises:
decoding, by the decoding side, a first code stream in the target code stream, to obtain second identification information;
obtaining, by the decoding side, a size of a to-be-encoded node in a target level of a tree data structure corresponding to the target point cloud frame; and
decoding a second code stream in the target code stream in a case that the second identification information indicates that the target point cloud frame enables an inter prediction skip mode, and the size of the to-be-encoded node belongs to a preset range, to obtain the first identification information, wherein the inter prediction skip mode refers to a mode in which point cloud information corresponding to a point cloud frame is not encoded.

10. The method according to claim 9, wherein the first code stream further comprises third identification information; and
the obtaining a size of a to-be-encoded node in a target level of the tree data structure comprises:
obtaining, in a case that the third identification information indicates that a point cloud frame sequence enables the inter prediction skip mode, the size of the to-be-encoded node in the target level of the tree data structure, wherein the point cloud frame sequence comprises the target point cloud frame.

11. The method according to claim 8, wherein the method further comprises:
in a case that the size of the to-be-encoded node in the target level of the tree data structure corresponding to the target point cloud frame is the same as a size of a node corresponding to a largest prediction unit (LPU), and the reference point cloud frame meets a condition for enabling local motion estimation, based on the target code stream, obtaining a second point cloud block matching the first point cloud block in the reference point cloud frame, and obtaining a motion vector of the first point cloud block relative to the second point cloud block; and
performing motion compensation on the second point cloud block based on the motion vector, to obtain the second point cloud block subjected to motion compensation.

12. An encoding apparatus, comprising a processor and a memory, wherein the memory stores a program or an instruction executable by the processor, and the processor is configured to execute the program or the instruction to implement the encoding method according to claim 1.

13. The apparatus according to claim 12, wherein the processor is configured to execute the program or the instruction to:
obtain a tree data structure corresponding to the target point cloud frame;
obtain a size of a to-be-encoded node in a target level of the tree data structure; and
copy, in a case that a preset condition is met, and the similarity between the first point cloud block of the target point cloud frame and the second point cloud block of the reference point cloud frame is greater than or equal to the preset threshold, the point cloud information of the second point cloud block or the point cloud information of the second point cloud block subjected to motion compensation to the reconstructed point cloud of the first point cloud block, wherein the first point cloud block is a point cloud block corresponding to the to-be-encoded node in the target level, wherein
the preset condition comprises one of the following:
second identification information indicates that the target point cloud frame enables an inter prediction skip mode; and
second identification information indicates that the target point cloud frame enables an inter prediction skip mode, and the size of the to-be-encoded node belongs to a preset range, wherein the inter prediction skip mode refers to a mode in which point cloud information corresponding to a point cloud frame is not encoded.

14. The apparatus according to claim 13, wherein the processor is configured to execute the program or the instruction to obtain, in a case that third identification information indicates that a point cloud frame sequence enables the inter prediction skip mode, the size of the to-be-encoded node in the target level of the tree data structure, wherein the point cloud frame sequence comprises the target point cloud frame.

15. The apparatus according to claim 12, wherein the processor is further configured to execute the program or the instruction to:
in a case that the size of the to-be-encoded node in the target level of the tree data structure corresponding to the target point cloud frame is the same as a size of a to-be-encoded node corresponding to a largest prediction unit (LPU), and the reference point cloud frame meets a condition for enabling local motion estimation, perform motion estimation on the first point cloud block, determine a second point cloud block matching the first point cloud block in the reference point cloud frame, and determine a motion vector of the first point cloud block relative to the second point cloud block; and
perform motion compensation on the second point cloud block based on the motion vector, to obtain the second point cloud block subjected to motion compensation.

16. A decoding apparatus, comprising a processor and a memory, wherein the memory stores a program or an instruction executable by the processor, and the processor is configured to execute the program or the instruction to:
decode a target code stream, to obtain first identification information; and
copy, in a case that the first identification information indicates that an encoding side copies point cloud information of a second point cloud block of a reference point cloud frame or a second point cloud block subjected to motion compensation to a reconstructed point cloud of a first point cloud block of a target point cloud frame, the point cloud information of the second point cloud block or the second point cloud block subjected to motion compensation to the reconstructed point cloud of the first point cloud block, wherein the point cloud information comprises at least one of geometric encoding information or attribute encoding information of a point cloud corresponding to the second point cloud block.

17. The apparatus according to claim 16, wherein the processor is further configured to execute the program or the instruction to:
decode a first code stream in the target code stream, to obtain second identification information;
obtain a size of a to-be-encoded node in a target level of a tree data structure corresponding to the target point cloud frame; and
decode a second code stream in the target code stream in a case that the second identification information indicates that the target point cloud frame enables an inter prediction skip mode, and the size of the to-be-encoded node belongs to a preset range, to obtain the first identification information, wherein the inter prediction skip mode refers to a mode in which point cloud information corresponding to a point cloud frame is not encoded.

18. The apparatus according to claim 17, wherein the first code stream further comprises third identification information; and
the processor is configured to execute the program or the instruction to obtain, in a case that the third identification information indicates that a point cloud frame sequence enables the inter prediction skip mode, the size of the to-be-encoded node in the target level of the tree data structure, wherein the point cloud frame sequence comprises the target point cloud frame.

19. The apparatus according to claim 16, wherein the processor is further configured to execute the program or the instruction to:
in a case that the size of the to-be-encoded node in the target level of the tree data structure corresponding to the target point cloud frame is the same as a size of a node corresponding to a largest prediction unit (LPU), and the reference point cloud frame meets a condition for enabling local motion estimation, based on the target code stream, obtain a second point cloud block matching the first point cloud block in the reference point cloud frame, and obtain a motion vector of the first point cloud block relative to the second point cloud block; and
perform motion compensation on the second point cloud block based on the motion vector, to obtain the second point cloud block subjected to motion compensation.

20. A non-transitory readable storage medium, wherein the readable storage medium stores a program or an instruction, and the program or the instruction is executed by a processor to implement the steps of the method according to claim 8.
